(19) United States
(12) Patent Application Publication
(10) Pub. No.: US 2018/0218451 A1
(43) Pub. Date: Aug. 2, 2018

(54) INTELLECTUAL PROPERTY PORTFOLIO MANAGEMENT SYSTEM

(71) Applicant: GRIFFITH HACK PTY LTD, MELBOURNE (AU)

(72) Inventor: Jurgen Bebber, Melbourne (AU)

(21) Appl. No.: 15/763,086

(22) PCT Filed: Sep. 23, 2016
(86) PCT No.: PCT/AU2016/050901

§ 371 Date: Mar. 23, 2018

(30) Foreign Application Priority Data
Sep. 24, 2015 (AU) 2015903902

(51) Int. Cl. G06Q 40/06; G06F 17/30; G06Q 30/04

(52) U.S. Cl. CPC G06Q 40/06; G06Q 30/04; G06F 17/30011

(57) ABSTRACT

A computer system based intellectual property (IP) portfolio management system, is provided. The system includes a data store configured to store data including user account data for a plurality of user accounts, a client interface providing user access to the system via a communication network by user computer systems or devices, a system controller in data communication with the client interface and data store via the communication network. The system controller includes a user interface and display module configured to facilitate data display to a user and receiving user input via the client interface, a user account module configured create user accounts and maintain user account information inclusive of access control of data stored in the data store for storing, updating and retrieving data stored in the data store, the data for each user including user account data, a portfolio activity controller configured to create and automatically administer a plurality of types of IP matters, each IP matter being associated with a user account, provide automated guidance of one or more activities in relation to each type of IP matter to a user and facilitate action for one or more activities in relation to an IP matter, and one or more integration modules, each configured to facilitate machine to machine communication between the system and an external IP system, whereby transactions between the external IP system and the system are executed under control of the portfolio activity controller.

### TECHNICAL FIELD

The technical filed of the present invention is computer system based intellectual property (IP) portfolio management system, in particular for facilitating obtaining and management of registered IP rights and other IP related matters.

### BACKGROUND

The process for obtaining registered intellectual property rights, such as registered trade marks, designs and patents requires ongoing monitoring of deadlines, outstanding actions, and correspondence. A single application may require many transactions between an applicant and the IP rights office. These transactions are often handled by suitably qualified and registered attorneys or agents on behalf of the applicant. IP agents will typically employ computer systems for monitoring filing, prosecution and ongoing maintenance of various IP rights matters. Such systems typically rely on a database storing data for each matter and a software based monitoring system executing on a server in communication with the database to monitor deadlines and required actions and generate reminders for the agents to take action. Conventional IP monitoring systems require manual data entry for deadlines and status updates. Although these known systems are reliable for monitoring deadlines and case status, this monitoring is dependent on the entered data which is subject to human error. Further, actions to follow up deadlines are typically manual, for example filing a response to an examination report and updating the data for a matter to reflect this event. The administrative burden created by the data entry for such systems is reflected in cost to applicants for the IP agent's services.

Many applicants choose to utilise IP agents to take advantage of the agent's access to sophisticated monitoring systems and professional expertise. However, some applicants, particularly businesses in the start-up phase, cannot afford to engage IP agent services or would prefer to divert such costs to other aspects of their business. Some applicants file IP rights applications themselves, to save on cost, but then have to assume the administrative burden of monitoring their IP rights applications themselves. This introduces additional risks of errors or oversights, in addition to the additional time and effort required to monitor deadlines. Further, reduction of overhead and risks due to manual data entry and processing is desirable and advantageous for IP agents and firms.

Applicants not located in the jurisdiction in which an IP right is to be filed are often reliant on local representatives to file such applications.

There is a need for IP portfolio management and filing systems that reduce the administrative overhead, particularly manual data entry.

### SUMMARY OF INVENTION

An aspect of the present invention provides a computer system based intellectual property (IP) portfolio management system, the system comprising:
a data store accessible via a communication network;
a client interface being executable on a user computer system or device having at least one processor, a communication network interface, and user input/output interface including a display;
a system controller in data communication with the client interface and data store via the communication network, the system controller including:
a user interface and display module configured to facilitate data display to a user and receiving user input via a user device executing the client application;
a user account module configured to create user accounts and maintain user account information inclusive of access control of data stored in the data store for storing, updating and retrieving data stored in the data store, the data for each user including user account data,
a portfolio activity controller configured to create and automatically administer activity for a plurality of types of matters, each matter being associated with a user account, and facilitate filing of IP rights applications via at least one IP office; and
one or more IP office integration modules, each configured to facilitate machine to machine communication between an IP office system and the portfolio activity controller, whereby transactions between the IP office and the system are executed under control of the portfolio activity controller.

In an embodiment the system controller further comprises a finance module configured to receive data indicative of any fees paid for an activity, generate an invoice for the activity, deliver the invoice and monitor for payment.

Embodiments of the system controller can further comprise an external IP system integrator configured to allow mirroring of data with an external IP system. The external IP system integrator can be further configured to interact with a finance system for monitoring payments and invoice status.

In an embodiment the portfolio activity controller is configured to enable automatic filing of trade mark applications at an IP Office based on entered IP data.

Another aspect of the present invention provides a method of filing an intellectual property (IP) right application via a computer system based IP portfolio management system, the method comprising the steps of:
receiving, by the IP portfolio and management system, a user input indicating a new filing request and IP right filing data;
in response to receiving the new filing request, a system controller of the IP portfolio management system performing the steps of:
creating a new matter data record in a data store and storing the filing data;
connecting to an IP office electronic filing system via a communication network;
processing the new filing request to submit data to file the IP right application via the IP office electronic filing system;
receiving filing confirmation from the IP office electronic filing system;
updating filing status in the matter data record;
generating a filing notification and invoice for output to the user via a client interface.

Embodiments of the invention can be configured to enable applicant self-management of a number of different aspects of IP application and IP portfolio management. Some aspects of IP application filing and management may be automated using embodiments of the disclosed system and methods.

### BRIEF DESCRIPTION OF THE DRAWINGS

FIG. 1 is a system overview block diagram,

FIG. 2 is a flow chart of an example of a user account setup process,

FIG. 3 is a flowchart of an example of a new matter setup process,

FIG. 4 is a flowchart of an example of a data entry processing for a new trade mark filing matter,

FIG. 5 is a flowchart of an example of a trade mark filing process,

FIG. 6 is a flowchart of an example of a search matter,

FIG. 7 is a flowchart of an example of an automated matter updating process,

FIG. 8 is an example of a dashboard display screen for an embodiment of the system,

FIGS. 9a-9d are screen shots giving an example of display reconfiguration in response to user input data,

FIG. 10 is a block diagram of an alternative embodiment of the system

FIG. 11 is a block diagram of alternative embodiment of the system.

### DETAILED DESCRIPTION

Embodiments of the present invention provide a computer system based intellectual property (IP) portfolio management system. Embodiments of the system provide an on line platform to allow applicants greater transparency and optionally self-management of aspects of their IP portfolio. The system is configured to automate many administrative tasks. System embodiments can also be utilised by IP professionals and also enables co-management of IP portfolios of one or more clients/applicants by the IP professional and clients/applicants.

The system comprises a data store accessible via a communication network, a client interface via which users access a system controller and data store via the communication network, the system controller being in data communication with the data store and the client interface. An embodiments of the computer system based IP portfolio management system comprises a data store configured to store data including user account data for a plurality of user accounts, a client interface providing user access to the system via a communication network by user computer systems or devices, and a system controller in data communication with the client interface and data store via the communication network. The system controller includes various functional modules to facilitate and automate many actions associated with management of an IP portfolio. A user interface and display module is configured to facilitate data display to a user and receiving user input via the client interface. A user account module is configured create user accounts and maintain user account information, inclusive of access control of data stored in the data store for storing, updating and retrieving data stored in the data store, the data for each user including user account data.

A portfolio activity controller is provided configured to create and automatically administer a plurality of types of IP matters, each IP matter being associated with a user account, provide automated guidance of one or more activities in relation to each type of IP matter. This module provides functionality to automate the handling of many activities associated with management of an IP portfolio, as is discussed below in more detail.
The system can also include one or more integration modules, each configured to facilitate machine to machine communication between the system and an external IP system. Transactions between the external IP system and the system are executed under control of the portfolio activity controller. The integration modules can be configured for interactions with specific systems, for example the integration modules can include: IP office integration modules, external IP firm system integration modules, finance system integration modules etc. A plurality of integration modules may be provided to facilitate machine to machine interaction with a broad variety of external systems utilised by IP firms, IP offices, corporations and individual users. The architecture of the system enables the IP portfolio management system to operate as an intermediary to multiple systems and provide data retrieved form the multiple systems to a user via a single user interface portal.

The IP management system is also configured to provide guidance to the user for monitoring and taking action in relation to their IP portfolio. The system can also be configured to automate many actions in relation to IP matters under control of the portfolio activity controller, for example querying IP right status, receiving and handling correspondence from an IP office or attorney, sending correspondence and filing IP office submissions including filing of applications. The portfolio activity controller is configured to interpret received data to identify a required action in relation to one or more matters; determine requirements for taking the required action; retrieve required data for the action; and automatically trigger execution of the required action. Retrieving data for an action can include controlling the user interface module to display data entry fields and information to guide data entry by a user.

Some embodiments of the system include an external IP firm system integrator enabling machine to machine communication with an external IP system to retrieve data from the external IP system and update data in the external IP system configured to monitor deadlines associated with each matter and generate reminders for deadlines. The portfolio activity controller can be configured to be responsive to the reminders and deadlines obtained from the external IP system. For example, a reminder associated with a matter generated by the external IP system and retrieved via the external IP system can be used to trigger action in relation to a matter associated with the reminder by the portfolio activity controller.

The system can also include one or more IP office integration modules, each configured to facilitate machine to machine communication between an IP office system and the portfolio activity controller. This enables the system to automatically execute transactions between the IP office and the system, executed under control of the portfolio activity controller.

The system enables a method of managing an IP portfolio wherein the registered user accesses the IP portfolio and management system, and in response to the user access, the system causing display via the client interface of a plurality of IP management activity options. The options can include any one or more of: generating a new matter, application filing, viewing deadlines, taking actions on ongoing IP matters, viewing account status, and making a payment. In response to receiving a user input indicating a selected option, data relating to the selected option is retrieved by the portfolio activity controller. Specific to the selected option the system generates at least one display based on the retrieved data. The display includes one or more data entry fields for the selected option and provided guidance and tools to facilitate data entry by the user. One or more data entry fields are arranged such that in response to first data input to the field the system controller is triggered to perform any one or more of:
modify the data entry display to add or remove one or more fields;
populate one or more fields with second data based on the first data;
calculate and display cost data based on the first data; and
updating the display in response to data entry to display user instructions or additional information.

Thus, the user is automatically guided by the system through the data entry to accumulate required data for the selected option. This accumulated data is then processed and automated actions executed in accordance with the selected option. The outcome for the selected option can then be displayed. The portfolio activity controller can be configured to automatically facilitate or execute many actions associated with management of an IP portfolio system, including automatically filing applications for IP rights.

The data store may be a database implemented using distributed network accessible memory resources, for example “cloud” based resources accessible via the Internet.

In alternative embodiments the data store may be a centralised database using dedicated non-volatile hardware memory resources accessible via a network connected server. The database structure is designed to store data for a plurality of IP matters and clients for access and updating via instances of the client application and by the system controller. The database structure stores data for a plurality of different individual matters associated with one or more users, and user account data. Matter data includes relationship data defining one or more of relationships between users and matters, and relationships from one matter to one or more other matters. In the context of the present system “matter” is a term used to refer to any IP right (regardless of lifecycle stage) and other work or activities associated with IP rights that may be relevant in the context of the IP portfolio system. For example, a matter may be a trade mark application, a patent application, a design application, a search, a watch service, an enquiry, an opposition, a non-use action, a licence, an assignment, an infringement opinion, a freedom to operate opinion, etc. A matter may be related to other matters, for example a trade mark application matter, a matter for assignment of the trade mark and a search for similar trade marks. Additional matters may be created based on an existing matter, for example an original trade mark matter for a trade mark filed in one country and associated convention or divisional application subsequently filed, related matters of this kind where one matter is derived from another are often referred to collectively as a “family”. Associating data to define relationships between matters is stored for each matter, and this data can be automatically generated by the system. A portfolio is a term used to refer to a group of matters typically related by ownership or controlled by one entity. In the system each matter can be tracked separately. Data for each matter is separately identified in the database structure.

The client interface can be a web browser or a client application executable on a user computer system or device having at least one processor, a communication network interface, and user input/output interface including a display. For example, the client application is executable on a personal computer, laptop, server, tablet computer or smart phone, the hardware of such devices comprising processing resources, volatile and non-volatile memory, transceivers for data communication, and user interface mechanisms such as keypad, keyboard, touch screen/pad, microphone, camera and display, the devices also comprise firmware and operating system software for driving the device hardware and supporting execution of software applications, such as the client application/web browser. The architecture for an embodiment of the system is a client server type architecture where the client application provides user interface functionality to allow users to access and manipulate the stored data and core system functionality is hosted and centrally maintained by the system controller. For example, a user may update their address details, and in response to this update, cause actions by the system to also update the address data at relevant IP offices where the user address is also an applicant address, the address update may also be automatically updated in an associated IP firm system based on the user initiated change. A “thin client” architecture may be used where minimal functionality is implemented in the locally executable client application and substantially all functionality is implemented in the system controller. Alternatively, a “thick client” architecture may be used where intelligent processing of data inputs and display can be implemented in the client application rather that this functionality all be supported from the system controller. Another embodiment provides a web page/web portal accessed via a web browser application to allow users to access the system functionality via the Internet. The system functionality may be implemented on a network accessible server or using distributed “cloud based” processing and memory resources. Other architecture variants are also envisaged within the scope of the invention.

The client application of an embodiment is a software application configured to allow a user to set up an account, add new IP portfolio matters, renew existing IP portfolio matters, enter data, export data, view and export IP portfolio information including financial data, and initiate actions such as application filing and payment of official fees. The client application provides an interface for users to access the system functionality, the users being applicants, IP professionals, IP portfolio managers, or other persons. The client application is configured to provide a user interface configured to graphically display information indicating status of multiple matters or multiple aspects of a matter on a single screen—to convey comprehensive “snapshot” information to a user on mater or portfolio level.

In some system embodiments the client application may be common for all users. In alternative embodiments different versions of the client application may be made available, for example, customised for different types of users or for different user requirements. For example, a version of the client application may be customised for a particular company or IP firm. The versions of the client application may also be customised to accommodate different languages or accessibility requirements. The client application may be configurable by the user. The client application will be discussed in further detail below.

The system controller is implemented using processing resources which may be dedicated processing hardware resources such as one or more servers or distributed networked processing resources accessible via a communication network such as the Internet. The system controller is in data communication with the client application instances and data store via the communication network. The system controller can be implemented using a plurality of functional components or modules each configured to control different aspects. For example the system can include a user interface and display module, a user account module, a portfolio activity controller, and one or more IP office integration modules. The system controller can also include a finance module, an external IP system integrator and a report generator. The modules of the system controller are configured to provide functionality to allow the system to perform administrative tasks for management of an IP portfolio.

The user interface and display module is configured to facilitate user interactions via the client application or web browser depending on the system architecture implemented for the embodiment. For example, facilitating data display to a user and receiving user input via a user device executing the client application or via a web browser.

The user account module is configured create user accounts and maintain user account information inclusive of access control of data stored in the data store for storing, updating and retrieving data stored in the data store, the data for each user including user account data.

The portfolio activity controller is configured to create and automatically administer activity for a plurality of types of matters, each matter being associated with a user account. The portfolio activity controller can also facilitate user initiated filing of IP rights applications via at least one IP office. The system can include one or more IP office integration modules. Each IP office integration module is configured to facilitate communication between an IP office system and the portfolio activity controller, whereby transactions between the IP office and the system are executed under control of the activity controller. For example, an IP office integration module configured for automatic interaction with the Australian patent office (IPAustralia) business to business (B2B) portal to enable actions such as electronic filing of trade mark applications, receiving electronic correspondence, filing responses to examination reports and querying application status. Similarly an IP office integration module may be configured for automatic interaction with electronic filing portal for the US patent and trade mark office (USPTO). Further embodiments facilitating interaction with electronic portals of other IP offices are also envisaged.

The finance module is configured to receive data indicative of any fees paid for an activity, generate an invoice for the activity, deliver the invoice and monitor for payment.

The system can also include an external IP system integrator configured to allow mirroring of data with an external IP system. For example, to allow mirroring and automatic updating of data in an IP firm database and monitoring system, such as the Inprotech™ system supplied by CPA Global. The external IP system integrator can be further configured to interact with a finance system for monitoring payments and invoice status.

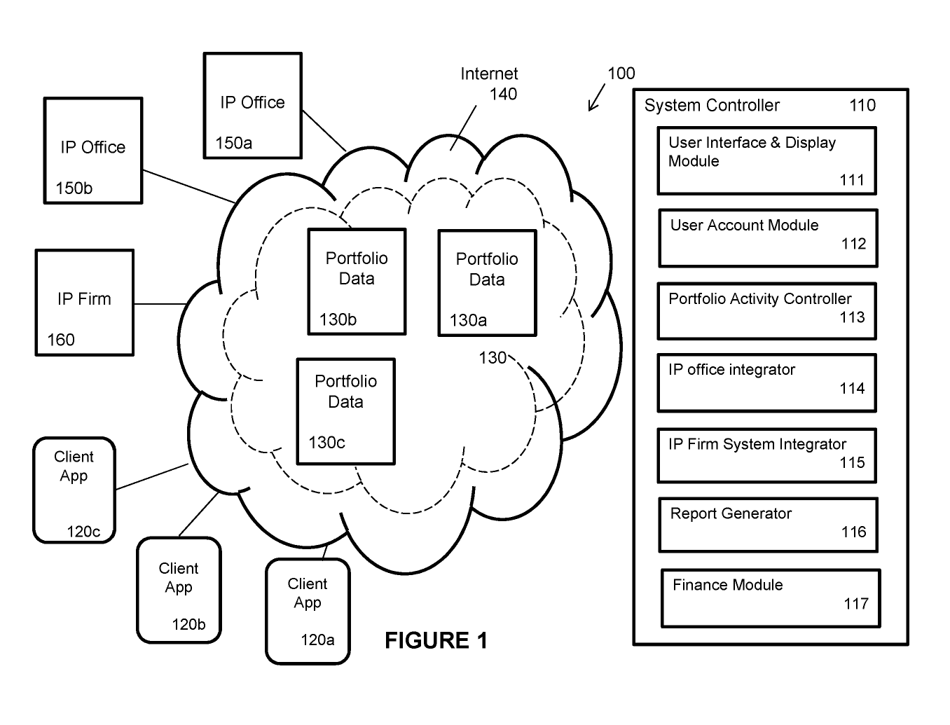

The system will now be described with reference to an example of setting up a user account and new IP portfolio matters. An example of a system is illustrated in the block diagram of FIG. 1. The system 100 comprises the system controller 110, cloud based distributed data storage 130 accessible by the Internet 140, and multiple instances of a client application 120a, 120b, 120c.

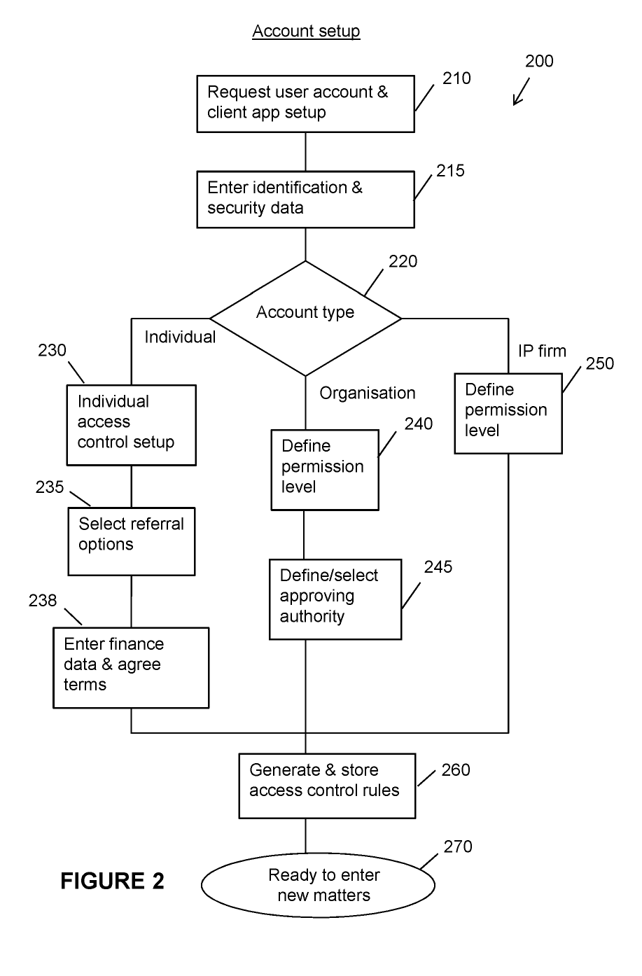

To utilise the system a user must first set up a user account. To initiate a user account set up a new user account the user may access a website enabling initial download of the client application 120a, which in turn, triggers an account set up process as shown in the flown chart of FIG. 2. Alternatively, a user may open an installed instance of the client application 120a and select a “new user account setup” option.

The user confirms the request to set up a new user account via the client application 210, and in response to this user action the client application will via a data signal to system controller 110 trigger the user account module to initiate a new account setup process. In response to this trigger the user account module initiates a template new user account record in the data store 130 and via data communication with the client application receives data entered by the user.

On the user's device the client application 120a displays a new user data entry display screen, displaying fields for user data entry. Some of the fields may be mandatory and some fields may be optional. The use enters user identification data in the display fields, such as a username, e-mail and other contact details and also security data such as a password or access code. If a user is adding a new user account associated with an already established account, for example for an organisation or IP firm, the user may be given the option at step 215 to nominate or select from a list a holder of a multiuser type account for the user to be associated with. In response to receiving an input indicating the user selection, the selection is communicated to the user account module in a data signal, in response to receiving the selection data the user account module retrieves the multiuser account data from the data store 130, which is then used to populate displayed data entry fields and the user record. The user account module can also automatically populate data fields for the multiuser account holder with previously stored new user identification data.

The system can be implemented to accommodate different types of accounts. For each type of account, different processing may occur in the system for new user account set up. For example, for an individual account, typically a new user account set up will be the initial account set up. In this instance the system will guide the individual requesting the new account through steps for setting up all information required for a new account by displaying a set of data entry displays and data entry fields specific to the new account setup for an individual. This facilitates the user entering all the data required. In addition to identification and contact details entered via data entry fields, the system can also display data entry fields for setting access control parameters 230, to define permissions for the individual user account to be applied to matters generated for that account. For example, the permission options displayed may include whether or not to allow matters associated with the individuals account to be viewed by any other system users or to have statistics from the user's matter included in consolidated system reports. It is envisaged that embodiments of the system can be hosted by an IP firm, which can also provide easy access to advice by IP professionals, or referral of matters to the hosting IP firm by the individual if they require professional assistance. In such embodiments additional fields may be displayed to enable input of permissions in relation to the hosing IP firm. It may be that individuals will allow the hosting IP firm access to monitor some matter data before any specific referral to the IP firm has been made, for example to allow the IP firm to monitor use statistics for the system and outcomes for self-managing applicants. In some embodiments system users may foster a sense of community or collaboration by sharing some data. For example, an individual may allow information that is otherwise publicly accessible to be accessible for generation of reports, such as statistics on applications filed or accepted via the system within the past month, viewed by users of the system via the client application. Alternatively, an individual may choose to keep all their account data and matter data hidden to other system users.

The step 235 includes the system displaying data entry fields to allow individuals to set up referral options at a user level. For example, the user may be able to select an option to automatically refer a matter to an IP firm in the instance of a particular event, for example in the event of an adverse examination report or notice of opposition. An option may also be provided to enable users to define standing instructions for routine actions, such as payment of renewal fees. Data entry screens are displayed providing a list of selectable standing instruction options, the system may automatically update the display based on input selections to automatically guide the user through entering the standing instructions. In response to standing instructions being entered, rules may be generated for the client and stored to control automatic execution of these instructions by the system. For example, for each account the system may maintain a main data file wherein such instruction are stored along with data that is to be common to all of the matters for an account holder, for example, data such as contact data, permissions, standing instructions, financial data etc. When a referral is made, the system automatically updates the permissions for a matter at matter level to allow the referred IP professional to access the matter.

In step 238 the system displays data entry fields where individual can enter finance data, such as a credit card number authorised for use for automatic electronic payment transactions, such as payment of filing and renewal fees, and any additional billing data, such as a billing address (which may be an email address) or entity for receiving invoices. Some embodiments also allow set up of rules for interaction with a user's electronic billing system. The system may also display a data entry field or button where an individual can also agree to terms and conditions of the system in step 238.

If the user account is being set up for an individual who is part of an organisation the system displaying data entry fields to allow the user's permission settings to be set up in step 240, for example the user's permission level may define whether or not the user has the authority to set up new matters or only work on existing matters. This may also include the system displaying data entry options for defining the types of action the user may be authorised to take, without requiring additional approval, and whether or not the individual is also authorised to approve payments or a payment limit for which the user is authorised to make. For example, a data entry field or tool (such as a slider) may be displayed to facilitate setting an approval limit, for example, a user may be authorised to file trade mark applications and incur costs only up to $5,000. For other actions, such as filing a notice of opposition, the user may require additional approval before the action may be completed. Similarly, if a trade mark filing requires filing in many countries and the authorised costs limit would be exceeded, further approval may be required to proceed. Data entry fields or section options are displayed by the system to facilitate entry of such options, and in response to one option being selected the displayed options may be modified based on the selection. For example, the system may remove options that become ineligible for selection based on the selected option or otherwise visually represent the ineligibility for selection—i.e. by “greying out” option buttons. Additional data entry fields or options may also be displayed based on selected options, for example to enable entry of more detailed data specific to the selected option.

Step 245 allows approving authorities to be defined within the system for the organisation, similarly by the system displaying data entry fields or options similarly to discussed above, for example an approving authority may be an IP manager or financial controller. Permission levels defined for users may also be used to control access for different matters. For example a user may have permission to view all matters within the organisation's IP portfolio but only take actions or edit data for matters associated with one group within the organisation.

Where the user account is being set up for an IP firm employee, it may only be necessary to define permission level for the user at step 250. The system may also simply display a data entry screen with options to confirm use of default permissions or customisation—which will trigger the system to display further data entry screens to capture customisation data. Where the user simply confirms default permission settings, for example allowing access to all matters for clients of the IP firm, the system applies (or leaves) the default permission settings. Alternatively where the custom option is selected further data is captured via displayed data entry screens, and the user account data amended in accordance with the input selections and data. Data for the user permissions may be updated with access to some matters may be restricted, for example for internal conflict and quarantine purposes due to sensitivity of different clients or subject matters. The system may also be configured to automatically set some permissions in accordance with rules defined in the system. For example, the system may set varying permission levels depending on the nature or status of the employee. For example the junior attorneys may be restricted from taking some actions in relation to matters, for example oppositions. In some embodiments for an IP firm the step 245 of defining approving authorities may also be applied. In step 260 the system generates access control rules based on the entered data and stores these for the user, to be subsequently applied by the user account module in subsequent system use. The account is now set up in the system and the system is now ready to automatically guide the user through the process to enter new matters 270.

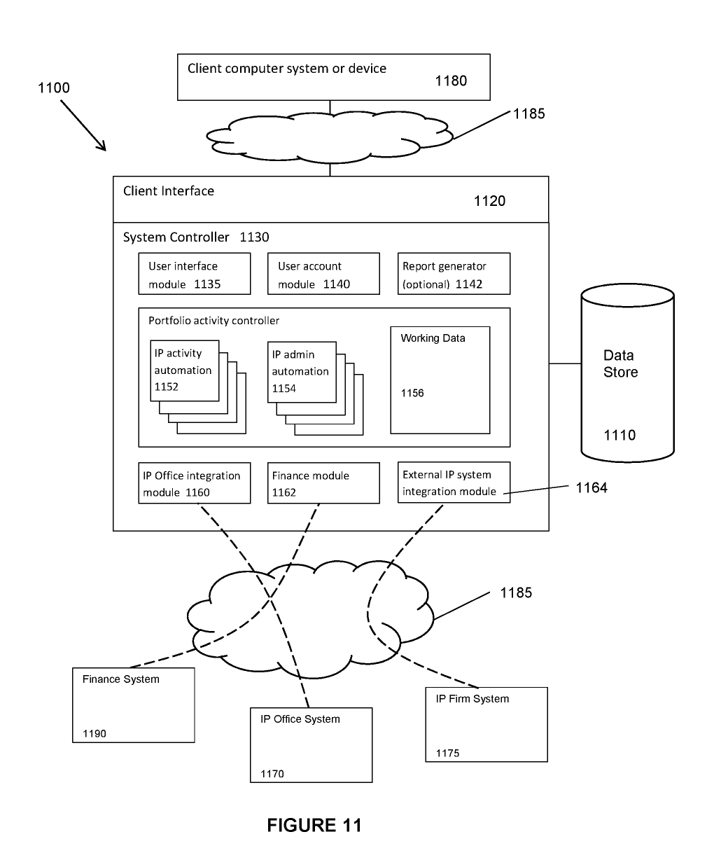

The activities for managing an IP portfolio are discussed below with reference to an example of an intellectual property portfolio management system shown in FIG. 11. The system 1100 comprises a data store 1110 configured to store data including user account data for a plurality of user accounts, a client interface 1120 providing user access to the system via a communication network 1185 by user computer systems or devices 1180, and a system controller 1130 in data communication with the client interface 1120 and data store 1110.

The system controller 1130 includes:
a user interface and display module 1135 configured to facilitate data display to a user and receiving user input via the client interface;
a user account module 1140 configured create user accounts and maintain user account information inclusive of access control of data stored in the data store for storing, updating and retrieving data stored in the data store, the data for each user including user account data,
a portfolio activity controller 1130 configured to create and automatically administer a plurality of types of IP matters, each IP matter being associated with a user account, provide automated guidance of one or more activities in relation to each type of IP matter and facilitate filing of IP rights applications via at least one IP office; and
one or more IP office integration modules 1160, each configured to facilitate machine to machine communication between an IP office system 1170 and the portfolio activity controller 1130, whereby transactions between the IP office and the system are executed under control of the portfolio activity controller 1130.

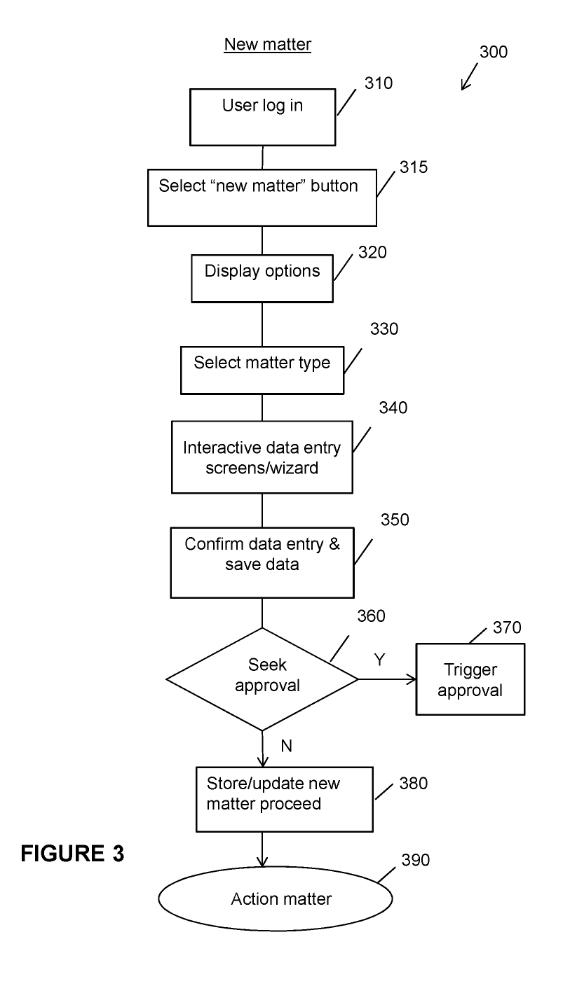

An example of entering a new matter now discussed with reference to flowchart of FIG. 3. The new matter process starts by the user accessing the system 1100, i.e. via a client application or browser to the client interface 1120 from their device 1180 and this triggers an account login 310 via the user account module. Login 310 triggers the user interface module 1135 to cause display of an initial display screen which includes action options for selection. In this example the user chooses a new matter option 315. In response to the user selecting a new matter option 315, for example by pushing a button or selecting a new matter tab from a list of options, the user interface module 1135 causes the client application to display a list of new matter options. New matter options may be displayed in a list, for example, listing file a new trade mark, file new international trade mark (Madrid), file new series of trade marks, renew trade marks, new watch, new search, retrieve internal trade mark, request trade mark takeover, add existing trade mark, make an inquiry. Based on the option selected, this may trigger display of additional options. For example, if a watch is selected then different types of watch options may be presented for selection, such as a name watch, mark watch, or parameter watch. Once the matter type is selected 330, this triggers the user interface module and portfolio activity controller to execute an interactive data entry process to guide the user through and facilitate entry of the required data for the action. This process is controlled by the portfolio activity controller based on rules defined for the selected matter type and may include jurisdiction specific rules. The portfolio activity controller may access numerous set of rules and defined process flows for IP activity automation 1152.

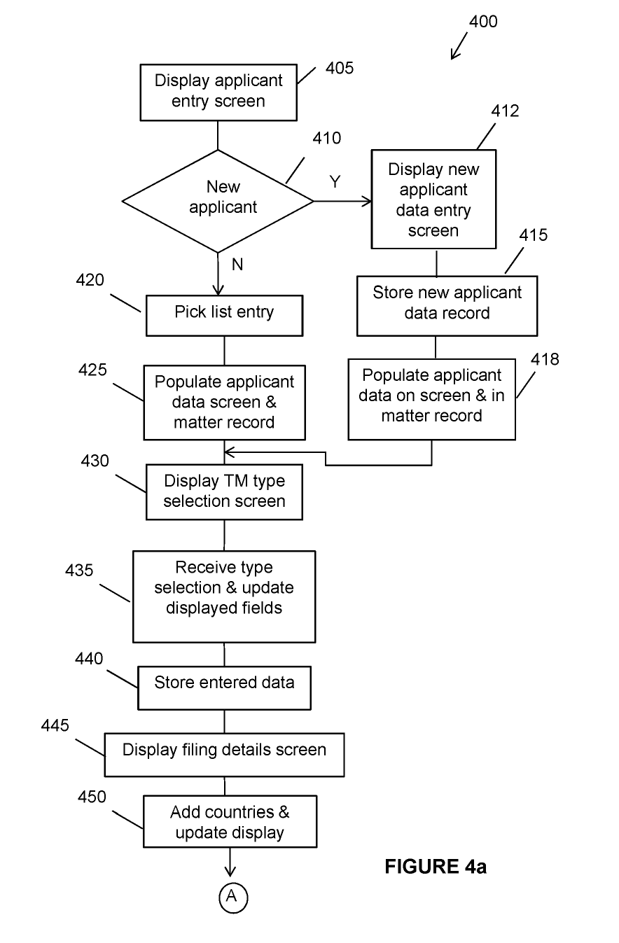

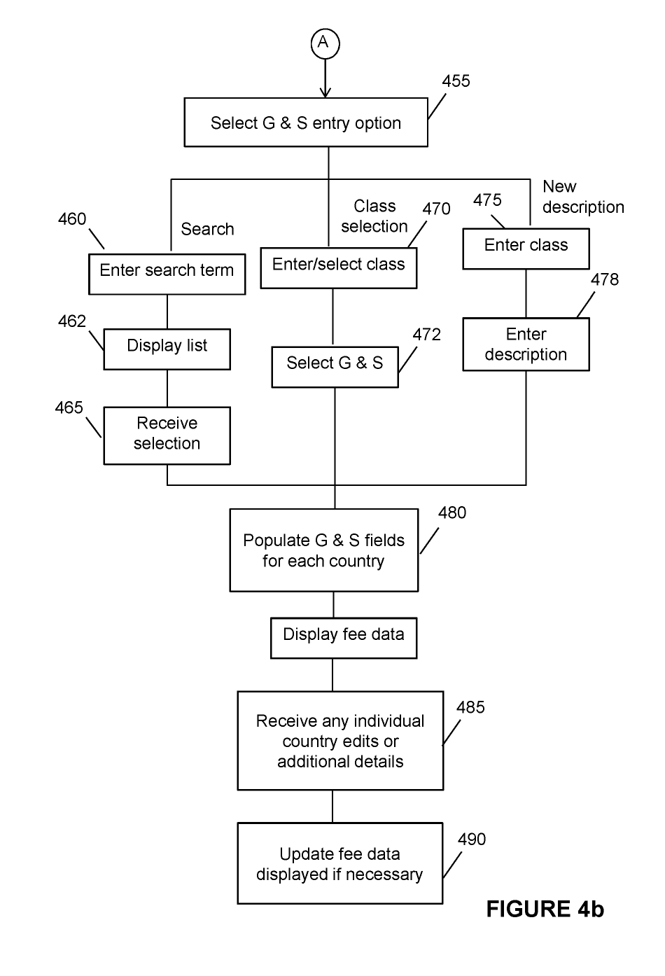

An example of a process for entering trade mark filing data is shown in FIG. 4. First an applicant data entry screen is displayed 405 and in this screen the user can select a displayed option to nominate whether the applicant is a new applicant 410 or an existing applicant—for which applications have been previously filed and the applicant data stored in the data store. If the user selects new applicant the user interface module updates the display screen is updated to display a new applicant data entry screen 412 displaying fields for entering applicant data, for example, applicant name, address, etc. The entered applicant data is stored in a new applicant data record 415 in the data store 1110 and the new applicant data is also used to populate the data displayed in the new matter entry screen and the new matter record 418. Where the matter is for an existing applicant, the portfolio activity controller can retrieve data for existing applicants for the user for display by the user interface module and client interface. The user may simply select the existing applicant from a displayed list of applicants, for example, using a pick list. Alternatively the data entry screen may provide a field to enter the applicant name with is utilised by the IP activity controller to search the applicant 420. The applicant data for the matter and displayed on the screen is automatically populated by the portfolio activity controller from the applicant data stored in the data store 425.

Next the trade mark type selection screen is displayed 430 and on this screen the user may select from a list of options the type of trade mark being applied for, for example a word mark, device, colour mark, scent, shape, sound, movement or other type of mark. Depending on the selection made the user interface module may automatically update the display screen, reconfigured to show additional fields for entry of data relevant to the trade mark type, for example type in the word, dragging and dropping an image file for a device mark, entering of endorsements, etc. The data entered in the displayed fields is stored and the filing details screen is displayed 445. The filing details display screen allows the user to select the countries in which the trade mark application is to be filed, for example using a search, selecting from a pick list, or from a clickable map. Once the input indicating selected countries is received via the client interface 1120 the display is updated to show the selected countries 450, the portfolio activity controller also updates the data record for the filing details with the selection. The user can then proceed to enter goods and services data 455. In this embodiment of the system, the User interface module and portfolio activity controller provide three different options for entry of goods and services data. The first option is a search where a search term can be entered into a data field 460 and in response to the search a list of classes and goods and services for a class are displayed in a selectable list 462. The user can then input the selection from the list 465. The second option is a class selection option where the user can select from a list of classes and select a class or subset of a class 470 and based on their selection 472 the goods and services data will be automatically populated. The third option is entering a new description for goods and services. In this option the user nominates a goods and services class 475 and then enters a text description of the goods and services 478.

In step 480 goods and services fields for each of the nominated countries are populated using the data entered via one of the above three options. The user then has the option to edit the goods and services data for individual countries/jurisdictions 485. In this step the user interface module can modify the screens to display fields or data entry tools for any additional information that is required based on the jurisdiction filing requirements may also be entered. For example, additional data fields may be displayed to invite the user to fill in or select additional filing data, for example advising whether or not a trade mark application is a divisional application for the Australian trade mark. Based on the entered countries and goods and services definitions the portfolio activity controller 1130 will determine the fees applicable for the trade mark filing and trigger the user interface module to display these on the display screens, for example at step 480 the fee data may be displayed and the fee data may also be updated in response to any changes made in step 485, if necessary, and displayed in step 490. This feature enables the user to understand the costs for the trade mark application filing during the process of defining goods and services and selecting countries. This has the advantage of making it simple for the user to make adjustments to the filing strategy and observe the impact on costs during this interactive data entry process.

Once the user is satisfied with the filing information entered they confirm the data entry, for example via a confirm button which triggers the portfolio activity controller to save the filing data 350 in the database 1110. In step 360 the portfolio activity controller via the account module checks user permissions. If the user is not authorised to file the application without seeking approval, then the portfolio activity controller can trigger an approval action 370, for example by generating and sending a notification to the approving authority and recording the input approval before the matter is updated at step 380 and proceeds to be actioned in step 390. For example, this may involve the portfolio activity controller generating a formatted message including the filing data details and forwarding the message to the approving authority, looked up in user account data. The message may be forwarded as a user notification in the system or via an external channel such as an email or instant message. In an embodiment the system may also be configured to generate copies of documents and attaching these to emails forwarded to the approver. In an embodiment, the filing details are stored in a temporary file 1156 until confirmation is received in step 350 or 380. In response to confirmation the portfolio activity controller can trigger set up of an individual matter for filing in each jurisdiction in the data store based on the data stored in the temporary file. In an embodiment where the system is configured to integrate with an IP firm system, the portfolio activity controller may, via the external IP system integration module cause the new matters to be created in the IP system 1175 database and mirrored in the database 1110 for the on line portal.

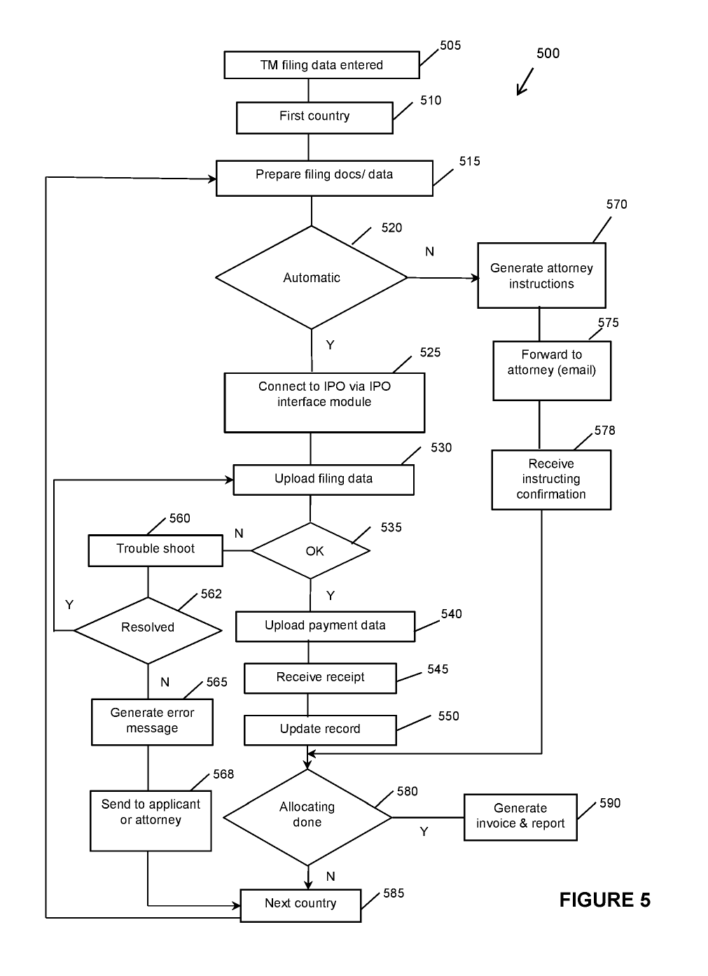

An example of the portfolio activity controller 1130 actioning a matter, in this example a new trade mark filing, will now be discussed with reference to the flowchart 500 of FIG. 5. In this example, the trade mark filing data is entered in step 505 as discussed above using the interactive data entry tool allowing data to be defined for multiple countries in a single trade mark filing data set up process. When the user confirms that the data entry is complete and to proceed with the trade mark filing, a new matter and data record can be set up for each country by the portfolio activity controller. The portfolio activity controller then executes actions to process the filing for each country in accordance with defined rules. Different procedures may be utilised for different countries depending on the availability of electronic filing at the Intellectual Property Office and whether or not the system is enabled with an IP office integrator tailored for that jurisdiction.

The portfolio activity controller 1130 selects a first country 510 and prepares filing documents or filing data based on defined rules or templates for the jurisdiction. For example, data memory associated with the system controller may store a plurality of template documents or data structures. These templates are applied to prepare documents or data files populated with data from the user data record and matter record for the trade mark application, previously entered as described above. This may include applying meta-data, to the filing data entered by the user, for filing automatically using an electronic IP office filing system 1170. The portfolio activity controller 1130 then determines whether the trade mark application will be automatically or manually filed in step 520. This decision may be based on system and IP office integration capability 11164 or user preference. For example, a user may request filing of the application to be supervised by an IP professional in a particular jurisdiction. The system may be configured to select automatic filing as a default where automatic filing is available and IP professional intervention has not been specifically requested.

Where an application is to be automatically filed, the portfolio activity controller 1130 is configured to establish data communication with the Intellectual Property Office 1170 via the IP office integrator module 1160 for the jurisdiction in step 525. For example, this may involve automatically generating and submitting account access/login data via the data network to log into the IP office electronic filing system. Once the appropriate connection is established, the prepared filing documents or data can be uploaded to the IP office system 1170 in step 530. The IP portfolio controller 1130 receives a confirmation message indicating successful data upload in step 535. Where the uploading of data is successful, the portfolio activity controller 1130 can trigger the IP office integrator 1160 to then proceed to upload payment data 540 for the filing activity. In response to the successful payment being received, for example receiving a payment receipt 545 the matter record 1110 can be updated 550, such as updating matter status as filed, record the official fees paid, and if provided with the filing confirmation to add the trade mark application number. Any other relevant information can also be updated at this stage, for example dates and any deadlines set by the filing date. For example, filing may set an examination request deadline or convention or divisional filing deadline. The portfolio activity controller 1130 can then check to determine whether the filing activity has been processed for each country 580 and if not the above process is repeated for the next country 585.

It is possible that during an electronic filing, a problem may occur, for example failure to correctly upload filing data or refusal of payment. If an error message is received from the IP office or if no confirmation of action is received from the IP office, a troubleshooting procedure 560 may be triggered in the portfolio activity controller 1130 or IP office integrator 1160. In which module the troubleshooting occurs may depend on system configuration or the type of error message returned. For example, if no acknowledgement of data upload is received the IP office integrator 1160 may assume that a connection has been lost and initiate reconnection. The IP office integrator 1160 may be configured to query the matter status to determine whether or not the data upload has been successful and if necessary trigger resending of the filing or payment data. Alternatively, if the problem cannot be resolved automatically, for example if a payment is refused it may be necessary to advise the user of the error. In this instance, the problem cannot be resolved 562 so an error message is generated 565 by the portfolio activity controller and sent to the applicant 568 and additionally or alternatively the error message may also be forwarded to an attorney. The IP office integrator 1160 can then close the connection to the IP office 1170 and the portfolio activity controller 1130 can continue on with the next country filing.

Where trade mark applications are manually filed, the system can still be configured to automate many steps in the filing process, for example the setup of the new matter, generating of attorney instructions 570, using template documents and data stored in the matter record. For example, in the step 570 of generating attorney instructions, the portfolio activity controller 1130 may be configured to select an IP attorney or IP firm from a list or database of options. The portfolio activity controller can use defined rules for selecting an IP firm or professional from a list of options or database, or a user may be allowed to select the IP firm or professional from a list displayed to the user. For example, during the trade mark filing data entry process for countries where automated filing is not an option the user may be presented with the option to have an IP professional automatically chosen by the system or they may be able to select from a list of options. Alternatively, one or more preferred firms or professionals for each jurisdiction may be allocated as default or preferred professionals for a user. For example, a company may select an IP firm to utilise for all of their matters in a particular jurisdiction and this selection may be applied by default. In other instances where no preference has been indicated by a user the portfolio activity controller may select an IP firm or professional based on predefined selection rules, for example using a rotation system, or expertise based selection, for example a firm may have a specialisation in particular types of trade marks such as sound marks and such track record of confidence criteria may be used to influence the firm or professional selected.

Once the attorney or firm is selected, the portfolio activity controller retrieves template documents, which may be specific to the firm in addition to the IP right, from the data store. The template documents are automatically populated by the portfolio activity controller with the appropriate data. The generated attorney instructions can then be forwarded to the IP professional or firm, for example via an automatically generated e-mail and sent via an e-mail client, for subsequent processing by the IP professional or firm. An acknowledgement of the instructions may be received 578 to confirm that the filing will proceed and the portfolio activity controller will, in response to receiving confirmation, continue to process the next country filing. Once all the requested applications have been filed or instructions sent, the portfolio activity controller can generate a filing report, either as data displayed on a display screen or as a formal reporting document and also trigger the finance module to generate an invoice for the filing activities. The invoice will include official fees paid, and processing charges for the trade mark filing.

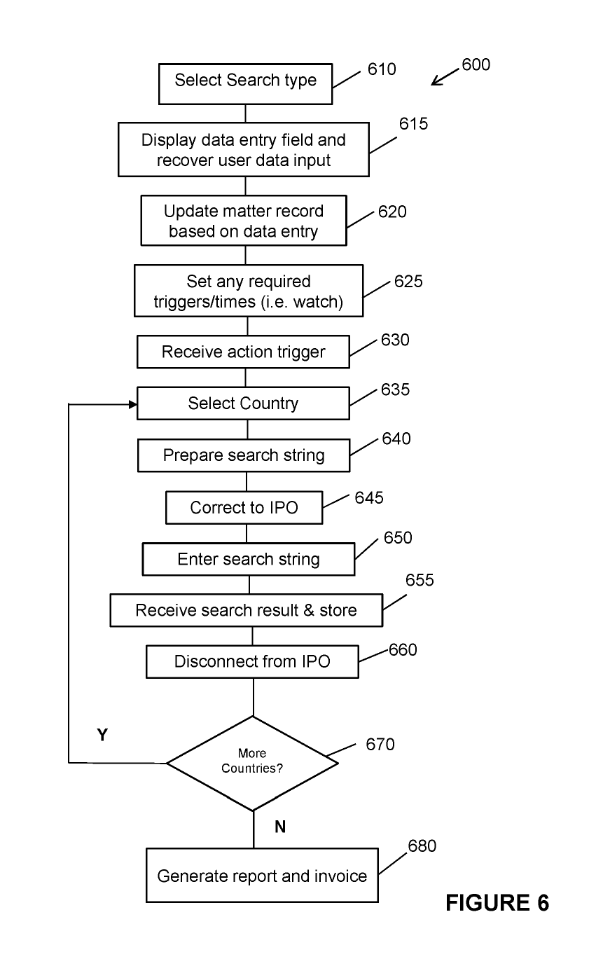

In another example, as shown in the flow chart of FIG. 6, embodiments of the system may be configured to automatically execute searches based on user defined search data. For example, for a trade mark search the user may select a new matter and select a search type matter 610. In response to the type of search selected the user interface and display module 1135 can be figured to trigger display screens for interactive data entry as discussed above. For example, allowing a user to input selected countries, mark data, name data or search parameters. The screens shown may be modified for each search type. The display screen may also provide tools for selection of search countries. For example pick lists, maps or text based search.

Record for the new matter is updated based on the data entry 620. This may trigger generation of multiple matters by the portfolio activity controller 1130, for example where the search is requested in multiple jurisdictions one matter may be instantiated for each jurisdiction. The activity controller 1130 can also set any required search triggers or timers that may be applicable 625. For example, a watch search may be requested to be automatically executed and reported each month. Alternatively, the search may be triggered for a particular date or in response to a particular circumstance, for example activity on a different matter such as an opposition or non-use action. Alternatively, the search may be immediately actioned.

In response to receiving a search action trigger 630, the portfolio activity controller 1130 will select the country 635. The appropriate search string is then prepared 640. For example, preparing a search string may involve selecting a language or particular search string syntax appropriate for the jurisdiction being searched. Such selections may be based on defined rules for the relevant jurisdiction. Once the search string is prepared 640 the portfolio activity controller causes the appropriate IP office integrator instance 1160 to connect to the relevant IPO 1170 645 and the search string is entered 650. A response including the search result is received 655 via the IP office integration module 1160 and stored by the activity controller 1130. Any official fee for the search can also be paid and recorded. The system disconnects from the IP office 660 and proceeds with the next country 670. Once search results have been received for all relevant jurisdictions the portfolio activity controller generates the search report and triggers the finance module 1162 to generate an invoice including any official fees and service charges for the search.

In the above process we discuss a search for multiple jurisdictions. However a search for a single jurisdiction is also envisaged. Further, a search may be defined for multiple trade marks for IP rights. For example, a search may be defined for three trade marks and in this case a separate search stream may be uploaded for each mark. It should be appreciated that the construction of the search string and the manner in which the search is executed may be influenced both by the limitations of the IP office system or chosen search methodology. For example an IP office may allow a search for multiple marks in a single search string. However, depending on the embodiment the search may be executed using three single mark searches.

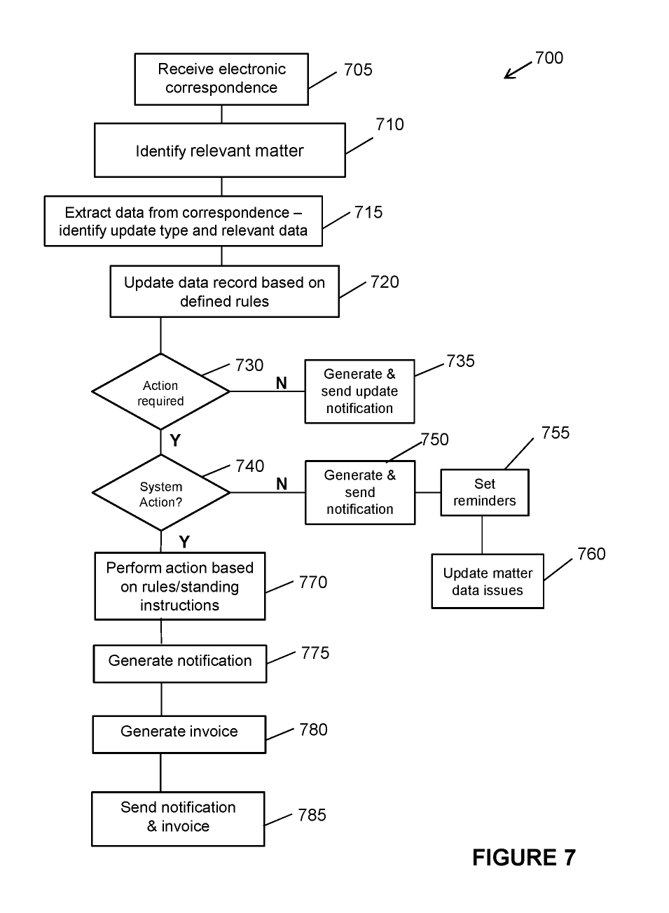

Embodiments of the system can also be configured to automatically update matters, for example in response to receiving correspondence from an IP office, applicant or attorney. An example of an automatic updating process flow is shown in the flowchart of FIG. 7. The process 700 is initiated by the system 1100 receiving electronic correspondence in step 705. The electronic correspondence may be automatically received via e-mail or B2B information update from an IP office. For example, an IP office integration module 1160 may be configured to automatically connect to the IP office electronic B2B platform 1170 to receive batch update data, for example comprising documents such as examination reports, filing receipts, acceptance notices, etc. and this data may also include notifications such as notification of lapsing or ceasing of rights or confirmation of renewal. Alternatively, the IP office 1170 may push such documents or status changes to the relevant address for service via e-mail and where the address for service is an e-mail address associated with the system, receipt of the e-mail will similarly trigger the update process 705. An updating process may also be triggered by receiving correspondence or instruction from an applicant or attorney, either via e-mail or direct input to the system via the client application. For example, an applicant may respond to an e-mail sent to the applicant's address informing of a fee deadline with instructions to either proceed to pay the fee or abandon the application. The applicant's e-mail reply is received at step 705 triggering the automatic update process. In another example, electronic correspondence may be receipt of an e-mail from a foreign IP attorney reporting an event such as acceptance or an examination report issued for a foreign application being handled manually in the foreign jurisdiction. In some embodiments the foreign IP attorney may also be provided with access to the system via a client application to directly enter the relevant correspondence rather than sending this via e-mail.

In response to receiving the electronic correspondence 705, the portfolio activity controller 113 processes the received correspondence to identify the relevant matter, or matters in step 710. Identification of the relevant matter may be via an identifier such as the IP right number or a matter identifier associated with the electronic correspondence. For example, where the received electronic correspondence is a reply to an e-mail, meta-data from the original e-mail embedded in the reply may be used to associate the e-mail reply with both the matter and original instruction identifying the action. Alternatively, the content of the e-mail, starting with the e-mail header, can be searched for an IP right number or matter identifier. Where correspondence is received from a IP office pertinent information such as the IP right number may be identified using metadata to simplify information extraction.

The portfolio activity controller 1130 is configured to extract data from the correspondence, for example to identify the update type and any relevant data from within the correspondence 715. To this end the portfolio activity controller can include an information extraction engine which may apply one or more algorithms for identifying and extracting data from correspondence. For example, algorithms may include word recognition algorithms configured to search e-mail text for terms associated with different instructions or status information and upon identification of a particular term, for example acceptance, processing text in the vicinity of this term to confirm the nature of the correspondence and required date type based on typical wording and formatting of descriptions associated with different status types. For example the word acceptance may be associated with an examiner accepting an IP application after an examination, or alternatively, the word acceptance may be associated with a deadline for obtaining acceptance after examination. The information extraction engine can be configured to compare various pieces of information from within the text of a document to determine the nature of the correspondence and required action. Information in addition to the document may also be applied such as the current matter status as recorded in the system prior to receiving the correspondence and the origin of the correspondence. In some embodiments metadata embedded in the correspondence filed may inform the information extraction engine of the nature of the correspondence then identify pertinent information such as deadlines and application status.

Once the relevant information has been extracted from the correspondence the portfolio activity controller updates the data record for the matter based on defined rules, step 720. The portfolio activity controller then determines, based on the data extracted from the correspondence, whether or not further action is required 730. For example no action may be required in the case of receiving a notification of renewal or receiving a notification of the IP right lapsing or ceasing. In such circumstances the status of the matter may be updated and a notification of the update generated and sent to the applicant or matter owner. Where action is required 730, the portfolio activity controller then determines whether the action is a system action which may be automatically processed 740, or if action is required by the applicant or another party such as an applicant, IP professional, or payment authority.

Where the system cannot automatically take action, for example where the correspondence is an examination report that requires a response from the applicant, the portfolio activity controller 1130 is configured to generate and send a notification 750 regarding the correspondence to inform the matter owner that action is required. This may involve generating a reporting e-mail based on a template stored in memory and populating the e-mail template with information extracted from the correspondence and generated by the system. For example, a template e-mail may be defined with fields to be populated from the extracted data. For example, template e-mails for reporting IP office communications, such as examination reports, notices of acceptance, notices of opposition, may be stored in system memory and the appropriate template selected based on the identified correspondence type. The template document may include fields to be populated using data extracted from the IP office correspondence, for example setting out the correspondence type and any relevant deadline for the action, the relevant deadline may be extracted from the document itself or calculated based on the correspondence date and defined rules associated with the action type. For example, where the date an examination report issues sets a deadline of 6 months to overcome all objections. Other fields in the template reporting e-mail may be filled based on data generated by the system based on action rules. For example the template letter may include a recommendation for timing a filing response or requesting instruction for referring the matter to an IP professional for assistance. The portfolio activity controller may also set reminders 755 in order to trigger subsequent follow up actions seeking instructions from the applicant or matter owner, the reminders will trigger automatic generation and sending of e-mails or other communication to the applicant or matter owner. The matter data may be updated in step 760 to record that the correspondence has been forwarded to the matter owner and reply is now awaiting for the matter.

Where the system may automatically take action based on the received correspondence 740, the portfolio activity controller will process the action based on rules or standing instructions 770. For example, where the electronic correspondence received relates to an IP right being accepted and an acceptance fee is payable, the portfolio activity controller may look for any standing instructions from the applicant or matter owner regarding automatic payment of the acceptance fee. Where the matter has associated with the matter or matter owner standing instructions to pay the acceptance fee, the portfolio activity controller will trigger and process the fee payment in accordance with the instructions. For example, this may comprise triggering of the IP office module to connect the IO office system to make the payment immediately. Alternatively, the system may store data files defining payment data for batch payments of official fees, which may include future dated payments. Where the acceptance fee is to be paid at a later date (say one week before the deadline) the portfolio activity controller determines the target date for making the payment and updates the relevant data file to schedule the payment. Whereby, the payment will be made as part of the batch payment of official fees on the scheduled day. This is one example of an automatic, standing instruction execution. The system may also be configured to enable automatic execution of some actions based on instructions within the received correspondence. For example, the received correspondence may be instructions to file documents attached to the correspondence at the IP office or otherwise respond to and IP office communication. For example, the instruction may be to file an assignment or response using documents attached to the correspondence. The portfolio activity controller will trigger the IP office interface to connect with the IP office electronic system and control uploading of the documents in accordance with defined rules for the action.

Alternatively the system action may be to refer a matter to an IP professional, for example to provide assistance to an applicant in deadline with an adverse examination report. This action may be initiated automatically upon identification that the IP office correspondence is an adverse report (if the system or matter has a standing instruction to do so), or in response to a user request for IP professional assistance. In this instance the portfolio activity controller selects an IP firm or IP professional for the referral (which may be in accordance with a user defined preference), then generates and sends a referral notification for the matter to the IP professional.

Once the appropriate system action has been automatically performed 770 a notification is generated to report the system action to the matter owner 775, and an invoice generated 780 including any official fees paid and any service charges. The notification and invoice is then forwarded to the matter owner 785, for example by e-mail.

For the above examples it should be appreciated that the system is configured to automatically process and execute many administrative actions associated with management of intellectual property rights that have traditionally been performed manually. An advantage of the system is that different integration modules can be provided to integrate with different electronic systems, in particular the electronic systems of IP offices and systems used by IP firms. Embodiments are also configured to integrate with accounting systems for invoice generation, payment and monitoring. It is envisaged that the system can be of particular advantage for self-filing applicants as the system facilitates entering of filing data for multiple jurisdictions using one input process flow, and facilitating (in some countries fully automating) application filing in multiple jurisdictions. The system also allows a user/applicant to manage all their IP matters via the client application. The system can also provide tools for aiding IP portfolio management, for example generating reports, monitoring deadlines, monitoring invoices and providing financial data reports.

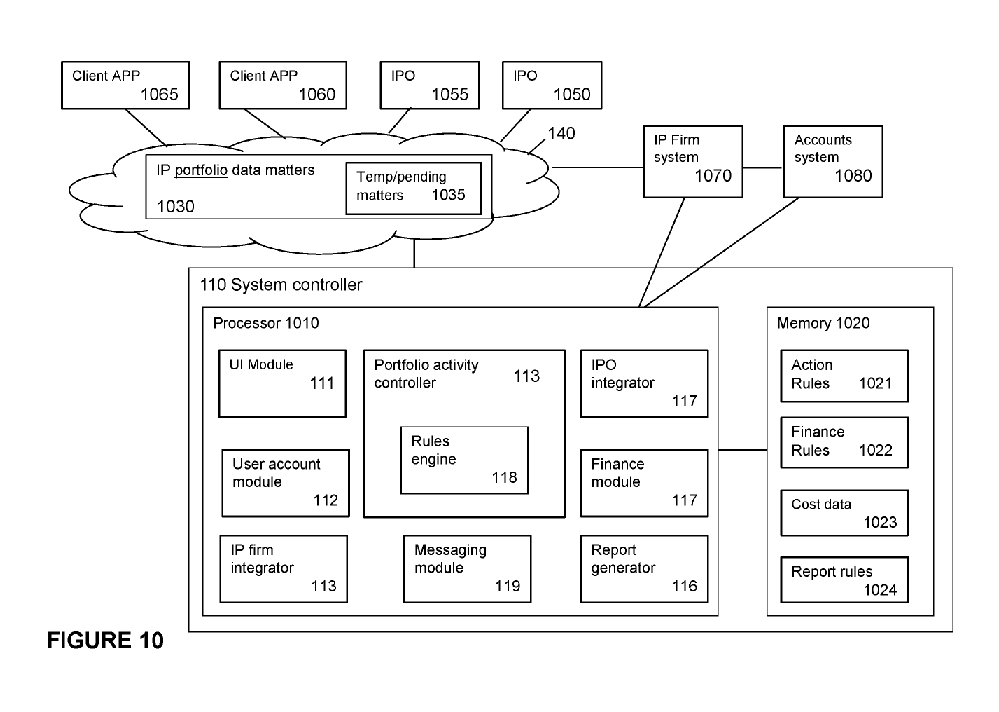

Different system component functionality is discussed in more detail in the following section where different system components are described in turn, with reference to FIG. 10.

User Interface and Display Module

The user interface and display module 111 facilitates display of data to users via the client interface—which can be a web portal or a client application. This module controls configuration of display screens and data entry tools made accessible via the client application, for example, drop down boxes, active lists, clickable maps, reactive display screen reconfiguration in response to data input. The user interface and display module can also be configured to provide interactive data entry via the client application, wherein displayed data fields can be automatically populated with data retrieved from the data store in response to user input and defined rules.

Further fields for data entry can be selectively displayed and display screens modified in response to user input based on defined data entry rules.

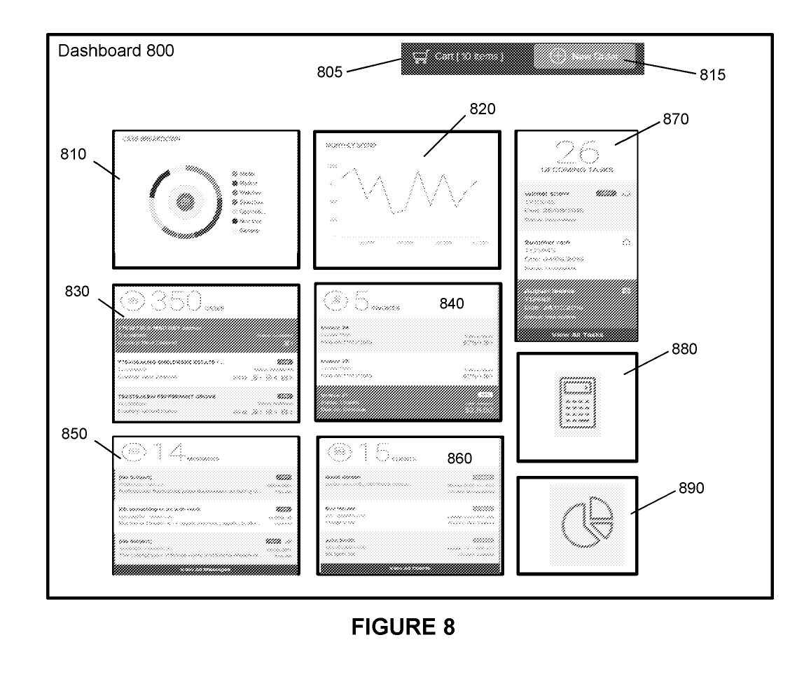

The display screens layout can be defined using any suitable web page methodology, for example HTML, XML, cascading style sheets, dynamic style sheets etc. and scripting for display on a user device executing the client application or browser, and allowing the user interface and display module to reconfigure the displayed data entry fields in response to instruction from the portfolio activity controller. A home screen can display a dashboard of summary information for the user's IP portfolio, such as the example shown in FIG. 8. The dashboard 800 of this example shows a number of boxes/tiles each providing a different perspective view of the user's portfolio information.

One tile shows a portfolio summary graph 810 giving an overview at a glance of the portfolio composition, additional information (such as the number of matters of each category) may be shown if a section of the graph is selected, for example by tapping or hovering over the graph section using a mouse, stylus or finger. The graph style may be configurable and an alternative to the circle plot (such as a pie chart or bar chart) may be used. Colour schemes such as shading or other visualisation methodology may also be applied to show breakdown between complete/registered and pending matters. A further tile 830 can be used to show a summary of the number of cases/matters in the portfolio. In the embodiment shown, summary information for some cases can also be displayed, the number of cases depending on the size of the tile and formatting. Different colours can be used to differentiate matter with a recent status change or outstanding activity pending. A full case list view or case detail view for an individual case may be entered respectively by selecting a cases tab or individual case.

A financial summary graph 820 can show an overview of IP expenditure, for example a monthly spend. An Invoices tile 840 allows a user to view list of invoices and invoice status. Colour or other visualisation methodology, such as boarders or icons, may be used to highlight new or outstanding invoices. A user may click on this tile to view a list of all invoices. Selecting an individual invoice (click or tap) will open an invoice details display screen. In an embodiment the use may select an option to pay an invoice from either an invoice summary or detail screen. In response to this selection is stored for processing via the finance module 117.

A messages tile 850 displays the number of new messages for the portfolio and a small selection of messages can be displayed. The messages tile 850 can be selected to change to a screen for viewing all messages. Another tile 860 may show the clients associated with a portfolio. For example, for an IP firm account the clients will include applicants, other attorneys, and matter instructors all of whom may also be system users, for an IP portfolio of a company this may show different department contacts as filing instructors and applicants, clients may also be inventors, invoicing entities, assignees and assignors etc. Selecting the client tile allows a full list of clients to be opened and browsed. Further tiles (not currently shown) may be provided for displaying other data, such as saved items, giving a list of items stored temporarily and not yet formalised as matters in the data store, for example new filing matters stored during data entry or on completion of data entry and pending conformation to trigger automatic filing.

An upcoming task tile 870 can be provided to display a list of matters with pending actions and colour may be used to highlight urgent matters. Other tiles may be provided to allow the user to access additional tools for functions. For example tools may include a calculator 880 to allow a user to obtain automatically calculated cost estimates for an action based on a subset of pertinent information before initiating a new matter setup process, a report generator 890 to allow a user to generate customised reports from their portfolio data, a deadline calculator to give an overview of timing for filing and prosecution for one or more countries based on entered dates etc. Examples of functions that may be initiated from a tile include, request IP right takeover or add existing matter, to include IP rights or matters initiated through other channels into the user's IP portfolio managed via the system. Other functions may be an “Ask an Expert” or “Help” function to contact a suitable IP processional, for example via email, instant messaging, phone or video connection for enquiries, depending on the embodiment.

The home screen may also be configured or an option selected to display the portfolio data sections 830,840, 850, 860 in lists rather than tiles. Alternatively the dashboard may simply display selectable icons or buttons for the different aspects of the portfolio and functions. A menu may also be provided for selecting portfolio information to view or functions.

A button or tab 815 may also be provided to view a new matter type selection screen, and select matter type for data entry as described above with reference to FIG. 3 and interactive data entry as discussed with reference to FIG. 4. The user interface and display module is configured to control the display screen reconfiguration during data entry. As described above, in response to data entered the portfolio activity controller can process the input data, determine the next required data based on an input selection by the user and defined data requirement rules for the action associated with the data entry. Then trigger the user interface module to cause different/additional data fields to be displayed. The user interface and display module may provide formatting data to control how the screens are displayed by the client application.

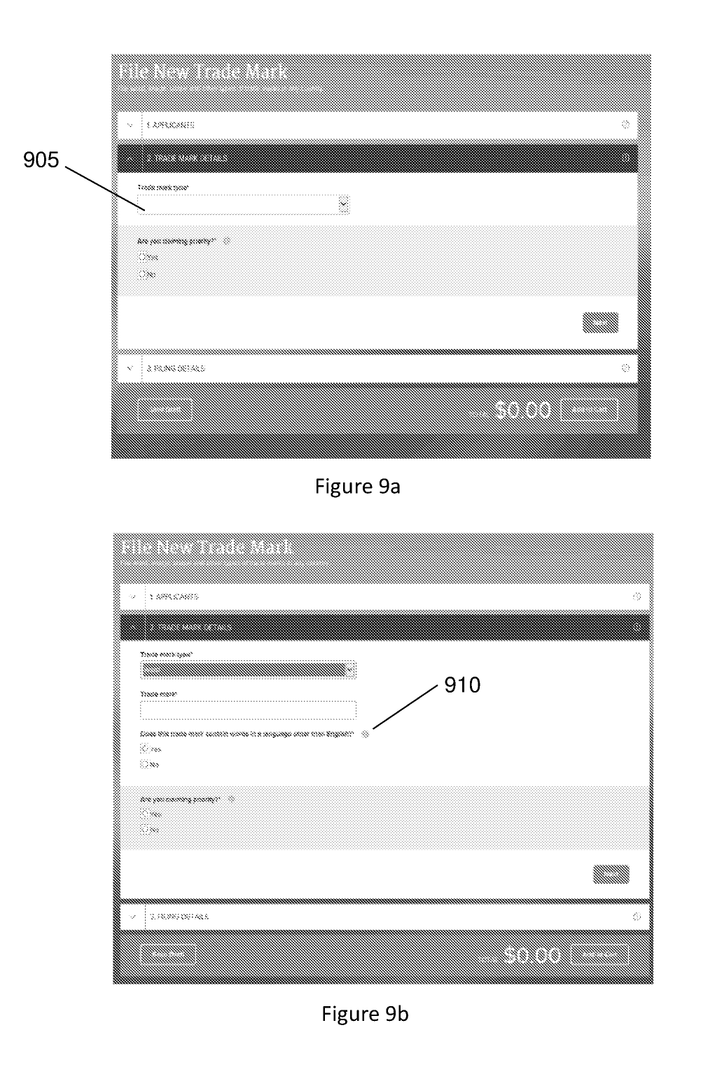

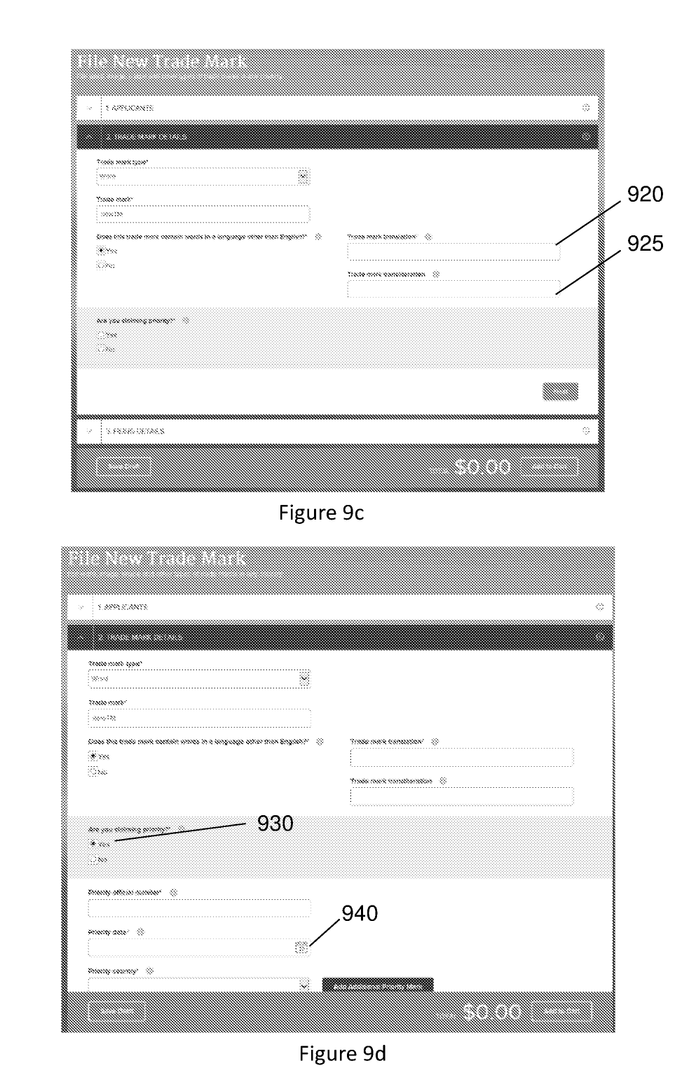

An example is shown in FIGS. 9a to 9d, with FIG. 9a showing an initial data entry screen for selecting trade mark type by entering data into a field or selecting form a drop down list for entry into the field 905. In response to data signal indicating the trade mark type selected by the user, the display screen is reconfigured to display data entry fields appropriate to the selected TM type, for example as shown in FIG. 9b for a word mark a text entry field 910 for entering the word mark is displayed and fields to enter whether or not the mark includes any words in a language other than

English, if the user input indicates “yes” then the display screen is reconfigured to show fields to enter a translation 920 and transliteration 925 of the word mark as shown in FIG. 9c. Similarly, when a priority claim is indicated 930, the display screen is reconfigured to display data entry fields 940 for entering priority claims details as shown in FIG. 9d.

The user interface and display module 111 can also be configured to provide facilities for entering active filtering parameters for displayed data. For example, filter criteria may be applied to a list of cases whereby matters may be displayed, ordered or display of matters suppressed in accordance with one or more filter criteria. In an embodiment filter criteria may be displayed for selection and applied in response to user selection to alter the displayed matters. Other display tools that may be provided include reordering of displayed items, expansion and contraction of list item details etc.

User Account Module

The user account module 112 is configured create user accounts and maintain user account information inclusive of access control of data stored in the data store for storing, updating and retrieving data stored in the data store, the data for each user including user account data.

It should be appreciated that embodiments of the described system can allow an applicant to self-manage their IP portfolio matters and, where necessary, request assistance from and IP professional. When an IP professional is referred a matter by an applicant the user account module will modify the access control parameters for the matter to allow viewing and action by the referred IP professional. Thus a new matter or copy of matter data is not required to be made, the IP professional is simply provided access to the applicant's matter data in the data store 1030. In embodiments of the system applicants and IP professionals both access the same data records. In some embodiments permissions on individual documents or data files may be used to prevent viewing by some users, for example a document in draft form may be kept private to the user (the IP professional) of the document or a class of users (IP professionals of the IP firm) for the matter so other users (the applicant) cannot view the document until it is released by the user of the document, say once the document is ready for review or filing.

Portfolio Activity Controller

The portfolio activity controller 111 provides core analysis and processing functionality for the system. The portfolio activity controller is also configured to selectively trigger operation of other modules, for example IP office interfaces, user interface module, finance module etc. based on the functionality required to execute an activity.

The portfolio activity controller 111 can be implemented as a software program executable using a processor 1010 and memory 1020. The memory stores sets of rules 1021 for different IP matters and associated actions. The functions provided by the software can include routines for process flows for each IP matter activity and a rule engine 118 utilised in conjunction with the process flows, the rule engine being configured to select rules for the defined process flow in accordance with input data, and control processing in accordance with the rule. Different sets of rules may be defined for each action based on jurisdictional requirements, such that criteria appropriate for the jurisdiction will be applied for decision making during execution of action process flows.

The portfolio activity controller may also be configured to convert data, where necessary, to appropriate formats for different jurisdictions, for example rules 1021 may define a required image file format for uploading image data for device trade marks. If the image format required for one jurisdiction is different form the image file input with the filing data the portfolio controller will identify that the image file does not comply with the required upload format and convert the image file. For example, converting a jpeg or PDF file to a bitmap.

It should be appreciated that the rules 1021 stored in memory can be updated in accordance with legislative changes. The process flows executed by the portfolio activity controller can be configured to fully automate some activities, for example trade mark filing in Australia, and some other activities may be semi-automated. For semi-automated activities the portfolio activity controller is configured to facilitate data entry by the user, by automatically displaying data entry screens, processing and storing input data. The portfolio activity controller also automates one or more administrative functions, such as creating and populating new matter records based on the input data, and preparing template documents or data files for subsequent use by an IP professional to use when executing manual steps for the activity. In particular embodiments of the system are configured to facilitate activity processing and minimise the steps requiring manual intervention or execution by an IP professional, with administrative steps being executed automatically under control of the portfolio controller. For example, for some actions the intervention by an IP professional may be reduced to reviewing, signing and mailing correspondence to an IP Office where hard copy documents and original signatures are required. For a user perspective all processes may appear to be automatically executed and there is no direct contact with an IP professional (unless specifically requested). This can allow reduced service charges and rapid activity execution.

The portfolio activity controller can also be upgraded to add new functionality, for example automating previously manual or IP professional facilitated steps if IP office practice changes or system changes to enable automation. In such instances the user experience of the system may not change, but steps previously facilitated by an IP professional are now automatically executed. Such an upgrade may also involve the introduction of a new or modified IP office interface module for the relevant IP office.

The portfolio activity controller may also be configured to trigger a referral to a professional in response to matter or portfolio level issues. For example, rules may be set to identify when particular circumstances occur and trigger a referral or other notification action. For example, a threshold IP spend within a financial year may be set as a trigger for referral to a taxation specialist. Other example of professionals for referral may be an investment group, funding body, development grant specialists, lawyers, commercial consultants etc. Referral assessment criteria can be defined in the system and may be applied at a matter, family to portfolio level. Referral criteria can be assessed by the portfolio activity controller and, when met, the portfolio activity controller generates a referral notification to the user (IP manger) or the referred professional. The notification to the user may include a request for reply (for example via system hyperlink) to indicate whether or not the referral is to proceed, and a notification only forwarded to the referred professional if the user accepts to be referral.

It should be appreciated that in some jurisdictions an applicant may not be authorised to self-file applications, requiring a local address for service which is typically an IP firm. System embodiments can be configured to be associated with a local IP firm so the IP firm address is used as the address for service and the system provides an interface between the IP office and applicant with intervention by the IP firm only when necessary or requested. In such instances the user/applicant still has the experience of self-managing their portfolio via the system, but this is facilitated via the IP firm with substantially all activity automated.

As discussed above the portfolio activity controller can be configured to automate many administrative functions, particularly to simplify and reduce the administrative burden on the IP portfolio manager (whether this is the applicant of an IP firm). This includes set up of new matters, which can involve importing or copying data from existing matters to automatically populate data files for the new matter and reduce data entry burden. For example, copying data entered for a word mark matter across to an associated device mark matter. Similarly data may be copied across for different types of matters, with the portfolio activity controller adapted to map data from one matter to another, for example using meta data associated with data entries. Types of matters related to or associated with a trade mark may include a search, opposition, divisional filing, Madrid or convention filing, general matter for a freedom to operate opinion or commercialisation advice, license or assignment etc. Rules for mapping data between different matter types can be defined in memory and applied by portfolio activity controller.

The portfolio activity controller may also be configured to integrate with an IP firm electronic record and monitoring system 1070, for example via an IP firm system integrator 115. In this embodiment the data store for the system may utilise the same database as the IP firm system or a separate database with matter records mirrored in the two separate data bases. In this embodiment actions may be initiated by the user via the client application or triggered from the IP firm system. The system may include a synchronisation function to periodically synchronise the two data bases and ensure consistent mirroring of data.

Various embodiments of the portfolio activity controller can be configured to automate functions including:
Instantiating new matters, storing matter data and taking automatic action if applicable
Updating matter status and optionally taking automatic action based on correspondence advising of status change at an IP office, received by the system via electronic communication form the IP office
Updating matters and optionally taking action based on user instruction,
Updating matters and optionally taking automatic action based on an a data entry or change entered in a connected IP firms system (i.e. inprotech) For example, correspondence to an associated IP firm received externally to the system may be entered into the IP firm system and an automatic updating of system data and any associated action triggered by a data signal from the IP office system
Updating matter data based on periodic synchronisation with an associated IP firm system
Updating matters in response to a push communication from an associated IP firm system indicating a matter update. This may optionally trigger automatic action by the portfolio activity controller.
Updating matter data in response to the system intercepting a communication, for example a filing confirmation signal from the IP office to the address for service, or e-mail to the user associated with a matter, for example an abandonment instruction e-mail.
Periodically querying matter status from an IP office and updating the system with any change, this may also trigger automatic action. For example, the system may automatically monitor to check whether or not renewal fees are paid, as these may be paid through channels other than the system. In response to a query to the IP office returning a reply indicating the renewal fee is paid, the status for the matter is automatically updated. Alternatively if a response to an IP office query indicates a renewal is overdue the portfolio activity controller may automatically generate and send a renewal overdue notification to one or more of the applicant, IP manager or IP firm responsible for the matter.
Filing of applications and reporting filing
Monitoring deadlines—including automatically updating deadlines in response to IO office communications and actions taken
Filing examination requests
Receiving and reporting examination reports—with optional referral to IP professional or option to select referral to IP professional, with referral triggered by a positive response
Filing and reporting subsequent responses (may be semi-automated requiring IP professional input)
Receiving notices of acceptance/allowance, updating status, reporting and fee payment
Receiving and reporting grant notices including updating matter status and generating and sending notification to the applicant/IP manager
Monitoring and payment of renewals
Filing documents for oppositions, trade mark non-use actions etc
Performing searches
Performing watches where the status of an IP right is periodically checked.
Filing assignment or change of ownership details requests
Importing into the system IP matters already applied for via other channels, for example retrieving trade mark data (local or international) instantiating new matter and populating with retrieved data, automatically sending address for service updated requests to relevant IP office
Forwarding enquiries to IP professionals
Triggering referral to other professionals or services based on referral rules
Trigger cost calculation and invoice generation. Cost calculation may be performed during data entry for a matter to give a user foresight of coats associated with the action. Invoice generation is triggered once action for the matter is taken. This is discussed in more detail with reference to the finance module.
Automated system triggered action based on standing instructions (i.e. renewal, exam req, or acceptance fee payment). Trigger criteria for the instruction are monitored, for example a timer or data in IP office correspondence. In response to the trigger criteria being met, identify the relevant matter, IP office and any relevant additional data (i.e. user finance data, official fee to input etc.). Connect to IP office via IP office interface and B2B using IP office interface instance for the relevant IP office and enter data automatically. In response to receiving reply communication/notification, update matter status and store data (i.e. e-filing receipt, payment confirmation, any deadlines etc.). Invoice calculation and generation is then triggered.

It should be appreciated that embodiments of the system are configured to operate to provide in intermediary services between existing systems, such as IP offices, attorney systems and accounting modules. In addition, the system adds intelligence into the intermediary system to enable the system to make decisions regarding activity required in relation to a matter at least partially automate actions. The ability for the IP management system to integrate with existing IP firm systems, means that the IP management system can be used to supplement the functionality of the existing IP firm system without requiring the firm to cease using the existing system.

In some embodiments (or even some jurisdictions) the IP management system can be configured to utilise the existing IP firm system for monitoring deadlines and the IP management system take automated action in response to these deadlines. This embodiment has a particular advantage in an IP management context where IP deadline monitoring systems require regular updating of monitoring rules due to legislation changes. By the IP management system being configured to automate processing and administrative tasks that rarely change, and querying deadline data from the existing IP system this is anticipated to reduce the frequency and magnitude of upgrading the IP management system. Further this allows a “soft” changeover from an attorney firm perspective, as the system enables working for either via the IP management system or the existing IP firm system—including the main database for the firm's matters.

Embodiments of the IP portfolio management system are also envisaged that implement IP firm system functionality, such as deadline monitoring, and automation of matter actions.

IP Office Integrator

This IP Office 114 integrator manages communication between system and IP office 1050. In instance of the IP office integrator 114 can be customised for each IP office 1050, 1055 providing an electronic filing system interface or enquiry interface for which the system is enabled. For example, an embodiment of the system may only integrate with a single IP office 1050, the local IP office, for automatic filing and other actions. In other embodiments the system may be configured with multiple IP office integrators, each customised for a different IP office and the appropriate instance called by portfolio activity controller based on jurisdiction and action being taken. IP Office integrators are customised for different jurisdictions, and may also be customised based on IP right type. For example, an IP office integrator may be customised for the Trade Mark Office of IP Australia and other IP office integrators customised for each of the Patent Office and Designs Office of IP Australia.

The IP office integrator is configured to:
Automatically connect to the IPO electronic filing and right maintenance system, for example, via an electronic B2B portal or emulating operator log in and data entry actions for an electronic system interface.
Trigger converting data to required format, for example applying metadata, populating template forms or data files, entering data into data entry fields.
Push data to the IP office system using IP office specified interface, for example uploading documents and/or data files, or forwarding correspondence via e-mail.
Receive reply communication from IP office system. This may be in response to action initiated by the system, such as filing an new application, or may be initiated by the IP office, such as an examination report.
Analyse, extract pertinent data, convert (if necessary) for storing in system. For example, pertinent data such as IP right number, deadlines, official fees etc. may be identified based on document format or meta-data associated with a document, data items in a document or data file.
Make payments, for example by entering credit card data, escrow service or specifying a user account code for an account with the IP office. This action may be administered by the finance module, triggered by the IO office integrator.
Some embodiments may also include translation functionality—for example for automatically providing machine translations of documents or notifications.
Some embodiments may also include functionality for integration with search engines. For example, for automatic generation of search strings using search syntax appropriate for the IP office search engine. Alternatively, the search engine integration may act as user emulator to enter data into data entry fields of an IP office search engine interface. The search engine nitration functionality may also be configured to download search results and format into a searchable format (for example, export to a spreadsheet or database) or report for delivery to the user.

Finance Module

The finance module 117 is configured to integrate with the portfolio activity generator for automatic calculation of costs during data entry for some matter types, and generation, sending and monitoring of invoices for matters.

The finance module 117 can also be configured to integrate with the IP office integrator 114 for making payments of official fees, for example be supplying credit card details, via a B2B interface and electronic funds transfer (EFT) payment or escrow service. The Finance module 117 in some embodiments may be configured to provide payment data to IP office integrator 114, for example credit card details, or to execute payment actions when triggered by the IP office integrator 114 or portfolio activity controller 111. For example, where payments are to be made via EFT or escrow the functionality for executing payment actions may be implemented in the finance module, whereby in response to the IP office integrator or portfolio activity controller triggering a payment request and providing payment detail data the finance module controls execution of the transaction and stores payment data to be applied as disbursement for invoices.

The finance module may also be configured to receive and process invoices received from IP firms for services in relation to a matter. For example, invoices may be received via email and data extracted from the electronic invoice document. Alternatively, an IP firm invoice may be uploaded to the system directly, for example from an IP firm also operating an embodiment of the system the finance module may be configured to provide an invoice in a data file format for automatic upload to the other IP firms system.

The finance module 117 is configured to calculate costs associated with a matter based on service charges for actions, official fees, any IP professional time based costs and other disbursements such as official fees paid and associated IP firm invoices. Service costs and official fees for all matter actions and jurisdictions may be defined and stored in one or more cost data files 1023 in memory 1020. This cost data 1023 may include estimates for IP firm services for matters, were applicable. The cost data may also include cost calculation rules to be applied for calculation of costs. For example a multiplier may be applied to official fees based on the number of classes for a trade mark, surcharges may be applied for processing particular types of data or services, for example translation of documents or late/rush fees, and rules defining the criteria for applying these surcharges or fees are also defined. Rules may also be defined for individual applicants or account holders, for example fee discounts based on entity size or client specific discounts on some charges. A calculator function is provided to prepare cost estimates for actins based on input data, defined costs and applicable rules. In a preferred embodiment costs estimates are prepared dynamically in response to data input for display on data entry screens, for example during filing details entry. The calculator function is configured to look up for an action the applicable costs and calculate a cost estimate based on the input data and cost rules for the action. Each data entry may trigger a calculation or recalculation of costs and the calculated estimate is displayed to the user during data entry. It should be appreciated that as the data entry process allows data to be prepared concurrently for actions in one or more jurisdictions (for example trade mark filing in multiple countries) the cost calculator may perform a cost calculation for each action (each country filing) and also aggregate the individual country costs to provide a total cost for the actions. Both per action and total costs can be displayed and dynamically updated during the input process.

The finance module may also be configured to integrate with an external accounting system 1080 (for example, the CMS™ or Expert™ systems supplied by Aderant) whereby financial data stored and processed in the accounting system can be accessed by the finance module for generating invoices, similarly data stored in the accounting system may be automatically updated by the finance module, for example to update costs incurred for an application. The finance module may also provide a web based interface to allow users to make invoice payments, for example via credit card, EFT or escrow, and facilitate automatic processing of such payments in the accounting system. For example, automatically monitoring for receipt of funds, updating the system to indicate the payment received. In some instances, in response to receiving payment of an invoice an action may be initiated to trigger payment of a disbursement billed in the invoice, for example an associate IP firm invoice. Payment of associate IP firm invoices is made in accordance with payment terms stored as finance rules, for example payment may be made automatically on expiry of a set time period for the data of the invoice (for example, 30 days), one a payment is received or a set period after receipt of payment from the user (for example, 2 days after user payment is processes). These rules may vary between system implementations and may also vary between different firms within the one system implementation.

Invoices are generated automatically by the finance module, typically on completion of an action. During execution of the action, say filing one or more trade mark applications, payments made to IP offices (or authorised for addition to an account at an IP office) are recorded as disbursement for the matters in the system. These charges may also be updated in an associated IP firm account system where integrated. For each matter the service charges are also calculated and recorded. IP professional charges may also be applicable for some actions, for example response actions where services of an IP professional were required to prepare response amendments and arguments. In an embodiment where the system is associated/integrated with an external accounting system of an IP firm, the IP professional may enter their costs, for example via a time recording interface. The finance module then looks up the IP professional charges for the matter in the accounting system.

The finance module of one embodiment generates invoices using the external account system functionality, for example triggering selection of costs incurred for a matter for verification by the finance module, for example to check that the actual cost recorded matches an estimated costs, and once verified triggers generation of an invoice via the accounting module. The invoice can then be appropriately formatted, if necessary, and invoice data updated in the data store and becomes viewable in the user's account via the client application. The invoice can then be forwarded to the user for payment, for example via email or facsimile. Alternatively the user may be notified of the new invoice via a notification displayed via the client application.

In an alternative embodiment invoices are generated by the finance module based on cost data stored for the matter. In this embodiment all invoicing functions are handled by the system. To generate an invoice the finance module looks up costs for a matter, including service charges, disbursements and IP professional fees, format an invoice document in accordance with a defined template, and apply a system unique invoice number for tracking purposes. The invoice data records are updated with the new invoice and the invoice is forwarded to the user.

Another embodiment of the system allows prepayment for actions via a “shopping cart” and associated payment interface (i.e. EFT, credit card, escrow etc.). In this embodiment the costs estimates calculated during data entry are stored and a payment record when an “add to shopping cart” selection is processed. When the user has completed data entry for matters, the user selects a “go to cart” option. This opens a page showing the items in the cart and total cost for payment. In response to the user selecting an option to confirm and proceed with the actions, a payment options screen is displayed and the user can enter payment details, some embodiments may also allow pre-stored payment details (such as credit card details) to be used. Once the payment is completed the portfolio activity controller proceeds to take action on each of the matters.

Invoices may be monitored by the finance module, for example by synchronising invoice status data stored in the system with account system data, or by a monitoring function for monitoring system managed invoices. For example an invoice monitor function may be configured to update an invoice status to “overdue” a specified period of time (for example 60 days) after the invoice is generated and forwarded. The monitor may also be configured to monitor payments received, for example via EFT to identify the invoice number in a payments received list received or downloaded from a financial institution and check the amount paid. Where the invoiced amount is paid in full the invoice status is updated to paid. Where a partial payment is received the invoice status may be updated to reflect partial payment and a notification generated and forwarded to the user to advise of the outstanding amount. Notifications of outstanding invoices may also be periodically generated and forwarded to the user.

A user may select one or more unpaid invoices from a displayed list of invoices to make a payment, in an embodiment this may be performed by an “add to cart” selection and using a “shopping cart” payment page as discussed above.

The finance module is further configured to generate for an IP portfolio one or more finance reports or graphs illustrating financial status of the portfolio. For example, a graph showing monthly expenditure for the user's IP portfolio displayed on a dashboard screen. Other reports may be generated, for example showing total spend broken down by portfolio section (for example business centre or department), applicant, matter type etc. Reports may also show expenditure over time, payment status, invoice pendency etc. Data may be output in tabular or graphical form.

Report Generator

A report generator module 116 is an optional module in the system as this module is not required to enable actions to be executed for matters. However, the report generator module can be advantageous for allowing users to monitor the IP portfolio. It is envisaged that the report generator is configured to output some standard reports based on predefined report generation rules, for example activity summary reports, IP portfolio status reports, matter activity reports etc. The report generation rules are stored in memory and can include defined database queries for extraction of data from the database for generation of the report, and report formatting data which may include instruction for generating graphs, tables, text and other manipulation of data for output or display. Reports may be generated on request or automatically in accordance with defined trigger criteria. For example, a portfolio summary graph 810 may be generated automatically in response to a user log in to ensure that the dashboard opens with a current portfolio summary graph. Other reports may be generated based on a defined period, for example quarterly reports. Reports may also be triggered based on user defined trigger criteria, for example an updated IP portfolio report generated automatically each time an IP right is granted.

The report generator may also allow a user to prepare customised reports. In an embodiment the report generator includes a rule generation engine configured to allow a user to select or input data defining the report content and format. For example, the rule generator may trigger display of a template report and allow a user to modify the format and select data on which to base the report. In another example the user may be provided with data entry fields whereby data for the report and formatting options can be selected. Essentially allowing the user to select and define the content and style of the report. Based on the user input the rule generation engine defines rules for generating the customise report, for example generating one or more database queries, equations for data manipulation or consolidation, visualisation methodology definitions for graphs or other stylised output of consolidated data, and report template format. The generated rules may also include trigger criteria for report generation, for example periodic and defining the time period. The generated report rules are stored to enable a user to recreate or further modify the report. The customised report functionality will allow a user to prepare reports based on any data stored for their portfolio.

In an embodiment the report generator may also allow uses to generate reports based on both their own IP portfolio data and data of other users where the other users have given permission for their data to be used by others for reporting or statistical analysis. Limitation may be imposed on the extent to which other users' portfolio data may be viewed or used. For example, cost data for other users may be restricted or anonymised.

In some embodiments of the system users may also be provided with an option to make their report template available to other system users. For example the report generator may allow users to select reports from a list including standard reports, the users own customised reports, and other's customised reports. Users may also be able to flag “favourite” reports or a “favourite” report section of the list automatically generated based on a user's commonly selected report formats, for example a user's 5 most commonly selected report templates.

Reports may be output for display via the user application or as documents which may be stored or printed by the user. In some embodiment the reports may be output in a readily editable data file format such as a spreadsheet or HTML document or less readily manipulated format such as a PDF file or image file. The report file format may be defined in the report generation rules.

Messaging Module

Embodiments of the system include a messaging or notification module 119 to facilitate communication with the system users. In a preferred embodiment email messaging is used and the messaging module comprises an email gateway and an email agent configured to automatically generate, send and receive emails from one or more email addresses. For example, a plurality of email addresses may be defined for use by the system each associated with a different function, for example, a Trade Mark email address for trade mark matters, a Patent email address for patent matters, an “enquiry” address for general enquiries, a “renewals” address for renewal matters, “finance” email address for invoice or accounts communications, etc. Some addresses may be configured to send and receive e-mails, for example an email address configured for automated communication between the system and an IP office. Other email addresses may be configured for sending emails only, as “no reply” emails. Emails sent using a “no reply” email address may include deadline reminder emails, such emails can include an embedded link to trigger opening of the client application and automatically directing the user to the appropriate matter and data entry screen to facilitate the user responding to the reminder. For example a renewal reminder for an IP right including a link (for example a hyperlink) to cause the client application to open to a renewal data entry screen with the IP right field populated with the IP right number. The screen may display selectable options “renew” or “abandon” and user input trigger the appropriate action, based on the selection.

The email agent can also be configured to trigger automatic action based on receiving an email, as discussed in previous examples. In response to receiving an email the agent extracts data from the email identifying the IP right or matter and nature of the action required. Action is then triggered accordingly and executed by the portfolio activity controller. Copies of received emails can also be stored in the data store, in the matter record or otherwise associated with the relevant matter.

In some embodiments communication or messaging system may be used, additionally or alternatively. For example, instant messaging services or store and forward type messaging services such as SMS, MMS or other messaging services may be used. For example, SMS or IM may be used to send urgent deadline reminders in addition to email communication. Instant messaging may also be used to enable contact with IP professionals.

Although the examples above have been described with reference to activities performed in the process of obtaining trade mark rights, it should be appreciated that many of these activities are also applicable to patent and design rights. Embodiments of the system can also support activities for obtaining and maintaining patent and design rights. In particular many matter handling and administrative functions are common to or handled similarly for all of trade mark, patent and design rights. For example, administrative activities such as generating new matters, generating invoices, generating reports, monitoring deadlines and forwarding reminders, referring matters to IP professionals, paying renewal fees etc. may use the same or substantially similar processing regardless of the type of IP right. Embodiments of the system may be configured to support patent and design rights by adding rules and process flows applicable to these rights without substantial change to the system architecture, however in some embodiments an IP office interface dedicated to the IP right type, for example patents, may be added. This may include automation of activities such as filing applications, requesting examination, receiving examination reports, filing responses, paying acceptance fees, recording amendments, recording assignments or changes of ownership, paying renewal/maintenance fees, and searching.

It will be understood to persons skilled in the art that many modifications may be made without departing from the spirit and scope of the invention. It should be appreciated that in the context of the present specification the terms “module” and “component” are used to refer to a system component implementing defined functionality. The system component can be implemented as a software program executable using a processor or as a software routine integrated into a software program providing additional functionality. The system component may be equally implemented using a combination of hardware and software. The disclosed embodiments may be implemented using any suitable combination of hardware, software and firmware, and may utilise a combination of shared and dedicated data processing hardware and memory resources. For example, a dedicated hardware circuit, such as an application specific integrated circuit (ASIC) or programmable logic, such as a field programmable gate array (FPGA) or programmable logic controller (PLC), may be used to implement some system functionality. This hardware circuit may be used in a data processing system having at least one processor, memory and other resources for executing cooperating firmware and software to support the full functionality of the system and integrate with external systems such as user terminals. It should be appreciated that many alternative system architectures could be used to implement the system and all such alternatives are envisaged within the scope of the present application.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A computer system based intellectual property (IP) portfolio management system, the system comprising:
a data store configured to store data including user account data for a plurality of user accounts;
a client interface providing user access to the system via a communication network by user computer systems or devices;
a system controller in data communication with the client interface and data store, the system controller including:
a user interface and display module configured to facilitate data display to a user and receiving user input via the client interface;
a user account module configured create user accounts and maintain user account information inclusive of access control of data stored in the data store for storing, updating and retrieving data stored in the data store, the data for each user including user account data, a portfolio activity controller configured to create and automatically administer a plurality of types of IP matters, each IP matter being associated with a user account, provide automated guidance of one or more activities in relation to each type of IP matter to a user for entry of IP data via the user interface and facilitate action for one or more activities in relation to an IP matter; and
one or more integration modules, each configured to facilitate machine to machine communication between the system and an external IP system, whereby transactions between the external IP system and the system are executed under control of the portfolio activity controller.

2. A computer system based intellectual property (IP) portfolio management system as claimed in claim 1 wherein integration modules include one or more of: IP office integration modules, and external IP firm system integration modules.

3. A computer system based intellectual property (IP) portfolio management system as claimed in claim 2 wherein the portfolio activity controller is configured to:
interpret received data to identify a required action in relation to one or more matters;
determine requirements for taking the required action;
retrieve required data for the action; and
automatically trigger execution of the required action.

4. (canceled)

5. (canceled)

6. A computer system based IP portfolio system as claimed in claim 53, wherein the data store is further configured to store matter data for a plurality of IP matters, each IP matter being associated with one or more user accounts and the external IP system integrator is configured to allow mirroring of data with an external IP system, whereby the data the matter data stored in the data store for each matter is mirrored with the external IP system.

7. A computer system based IP portfolio system as claimed in claim 3, wherein the system controller further comprises a finance module configured to determine any fees payable for an activity, generate a payment request and monitor for payment, and wherein the finance module is configured optionally to generate an invoice for the activity, deliver the invoice and monitor invoice status for payment.

8. (canceled)

10. A computer system based IP portfolio system as claimed in claim 7, further comprising an integration module configured to interact with a finance system for monitoring payments and invoice status.

11. A computer system based IP portfolio system as claimed in claim 3 wherein the portfolio activity controller is configured to automate filing of IP right applications at an IP Office based on entered IP data.

12. A computer system based IP portfolio system as claimed in claim 3 wherein the portfolio activity controller is configured to automate preparation of documents based on entered IP data and automatic forwarding prepared documents via the communication network.

13. (canceled)

14. (canceled)

15. (canceled)

16. (canceled)

17. (canceled)

18. A computer system based intellectual property (IP) portfolio management system, the system comprising:
a data store;
a client interface providing user access to the system via a communication network by user computer systems or devices;
a system controller in data communication with the client interface and data store via the communication network, the system controller including:
a user interface and display module configured to facilitate data display to a user and receiving user input via the client interface;
a user account module configured create user accounts and maintain user account information inclusive of access control of data stored in the data store for storing, updating and retrieving data stored in the data store, the data for each user including user account data,
a portfolio activity controller configured to create and automatically administer a plurality of types of matters, each matter being associated with a user account; and
an external IP system integrator enabling machine to machine communication with an external IP system to retrieve data from the external IP system and update data in the external IP system,
wherein the portfolio activity controller is further configured to identify a required action associated with the retrieved data and trigger a predefined process associated with the required action.

19. A computer system based intellectual property (IP) portfolio management system as claimed in claim 18 wherein the predefined process includes any one or more of:
notify the user of the required action;
execute an action using the external IP integration module;
update user account data; and
generate and forward a notification to a third party.

20. A computer system based intellectual property (IP) portfolio management system as claimed in claim 19 wherein a reminder associated with a matter generated by the external IP system is retrieved via the external IP system interface, interpreted to determine a required action and trigger action in relation to a matter associated with the reminder by the portfolio activity controller.

21. A computer system based IP portfolio system as claimed in claim 20, wherein the data store is further configured to store matter data for a plurality of IP matters, each IP matter being associated with one or more user accounts and the external IP system integrator is configured to allow mirroring of data with an external IP system, whereby the data the matter data stored in the data store for each matter is mirrored with the external IP system.

22. (canceled)

23. A computer system based IP portfolio system as claimed in claim 20, further comprising one or more IP office integration modules, each configured to facilitate machine to machine communication between an IP office system and the portfolio activity controller, whereby transactions between the IP office and the system are executed under control of the portfolio activity controller, and wherein the transactions between the IP office and the system include any one or more of: querying IP right status, requesting bibliographic information, requesting date information, requesting documents, filing IP right applications, receiving IP office correspondence, making submissions to the IP office, making payments and receiving payment confirmation.

24. (canceled)

25. A computer system based IP portfolio system as claimed in claim 23, wherein the system controller further comprises a finance module configured to determine any fees payable for an activity, generate a payment request and monitor for payment.

26. (canceled)

27. A computer system based IP portfolio system as claimed in claim 25, wherein the finance module is configured to generate an invoice for the activity, deliver the invoice and monitor invoice status for payment.

28. A computer system based IP portfolio system as claimed in claim 25, further comprising an external IP system integrator configured to interact with a finance system for monitoring payments and invoice status.

29. A computer system based IP portfolio system as claimed in claim 20 wherein the portfolio activity controller is configured to automate preparation of documents based on entered IP data and automatic forwarding prepared documents via the communication network.

30. (canceled)

31. (canceled)

32. A computer system based IP portfolio system as claimed claim 18 further comprising a messaging module configured to generate and transmit a notification to a user in response to an activity on an IP matter associated with the user, and wherein the notification includes an embedded link to trigger automatically accessing the IP matter via the client interface and display data to facilitate the user responding to the notification.

33. (canceled)

34. A computer system based IP portfolio system as claimed in claim 18 further comprising a report generator configured to generate and output preconfigured and customisable reports based on IP matter data assessable via the system.

35. A method of managing an IP portfolio via a computer system based IP portfolio management system comprising:
a data store configured to store data including user account data for a plurality of user accounts;
a client interface providing user access to the system via a communication network by user computer systems or devices; and
a system controller in data communication with the client interface and data store via the communication network, the system controller including:
a user interface and display module configured to facilitate data display to a user and receiving user input via the client interface;
a user account module configured create user accounts and maintain user account information inclusive of access control of data stored in the data store for storing, updating and retrieving data stored in the data store, the data for each user including user account data; and
a portfolio activity controller configured to create and automatically administer a plurality of types of IP matters, each IP matter being associated with a user account, provide automated guidance of one or more activities in relation to each type of IP matter, the method comprising the steps of:
accessing the IP portfolio and management system, by a registered user;
in response to the user access, the system causing display via the client interface of a plurality of IP management activity options, including any one or more of:
generate a new matter;
application filing;
view deadlines;
actions;
view account status;
make a payment,
and receives a user input indicating a selected option;
retrieving by the portfolio activity controller data relating to the selected option
displaying specific to the selected option at least one display based on the retrieved data, the display including one or more data entry fields for the selected option and providing guidance and tools to facilitate data entry by the user, wherein one or more data entry fields are arranged such that in response to first data input to the field the system controller is triggered to perform any one or more of:
modify the data entry display to add or remove one or more fields;
populate one or more fields with second data based on the first data;
calculate and display cost data based on the first data; and
updating the display in response to data entry to display user instructions or additional information,
whereby the user is automatically guided through the data entry to accumulate required data for the selected option;
processing the accumulated data and executing automated actions in accordance with the selected option; and
displaying an outcome for the selected option.
